(19) United States
(12) Patent Application Publication
(10) Pub. No.: US 2018/0110117 A1
(43) Pub. Date: Apr. 19, 2018

(54) SYSTEMS AND METHODS FOR CAPTURING GENERATED ELECTRON SPIRAL TOROIDS

(71) Applicant: Electron Power Systems, Inc., Acton, MA (US)

(72) Inventor: Clint Seward, Acton, MA (US)

(21) Appl. No.: 15/836,469

(22) Filed: Dec. 8, 2017

Related U.S. Application Data
(63) Continuation-in-part of application No. 14/185,605, filed on Feb. 20, 2014.
Application No. 14/185,605 is a continuation-in-part of application No. 13/737,519, filed on Jan. 9, 2013.
(60) Provisional application No. 62/432,211, filed on Dec. 9, 2016.
(60) Provisional application No. 61/710,417, filed on Oct. 5, 2012.
(60) Provisional application No. 61/631,733, filed on Jan. 10, 2012.

(51) Int. Cl. H05H 1/48; H05H 1/04; H05H 1/00

(52) U.S. Cl. CPC H05H 1/48; H05H 1/0025; H05H 1/04

(57) ABSTRACT

A spheromak is a plasma of ions and electrons formed into a toroidal shape. A spheromak plasma can include electrons and ions of nearly equal amounts such that it is essentially charge neutral. It contains large internal electrical currents and their associated internal magnetic fields arranged so that the forces within the spheromak are nearly balanced. The spheromak described herein is observed to form around an electric arc in partial atmosphere, and is observed to be self-stable with no external magnetic containment. The spheromak can be captured using a capture system. The spheromak can be accelerated through an accelerator tube.

### CROSS REFERENCE TO RELATED APPLICATION

The present application claims priority to U.S. Provisional Application No. 62/432,211, filed Dec. 9, 2016, and is a continuation-in-part of U.S. application Ser. No. 14/185,605, filed Feb. 20, 2014, which is a continuation-in-part of U.S. application Ser. No. 13/737,519, filed Jan. 9, 2013, which claims priority to U.S. Application No. 61/631,733, filed Jan. 10, 2012 and which claims priority to U.S. Application No. 61/710,417, filed on Oct. 5, 2012, the entire contents of these applications being incorporated herein by reference.

### BACKGROUND OF THE INVENTION

A spheromak can be defined as a toroidal shaped arrangement of plasma consisting of electrons and ions. Traditional spheromaks contain large internal electrical currents and their associated magnetic fields are arranged so the forces within the spheromak are nearly balanced, resulting in confinement times of about a few microseconds without any external fields.

Spheromaks can be generated using a “gun” type device that ejects spheromaks off the end of an electrode into a holding area called a flux conserver. This has made them useful in the laboratory setting for analysis, and spheromak guns are relatively common in astrophysics laboratories. Spheromaks have also been observed to occur in nature as a variety of astrophysical events, like coronal loops and filaments, relativistic jets and plasmoids.

Spheromaks have been proposed as a magnetic fusion energy concept due to their confinement times, on the order of a few microseconds, which was on the same order as the best Tokamaks when they were first being studied in the mid-twentieth century. Though they had some successes, these small and lower-energy devices had limited performance.

It has been demonstrated that hotter spheromaks have better confinement times, and this has led to a second wave of spheromak machines. Spheromaks have also been used as a mean of injecting plasma into a bigger magnetic confinement experiment like a Tokamak. However, there remains a significant need for improvements in the generation of stable toroidal shaped particle assemblies for a variety of applications.

### SUMMARY OF THE INVENTION

The present invention relates to systems and methods for generating electron toroids. This is formed in partial or full atmosphere where it is observed to remain stable for hundreds of milliseconds with no external magnetic field for confinement. The charged particles in this spheromak produce a strong internal magnetic field. A spiraling path for the electrons in the surface of the spheromak produces a large internal magnetic field, hence the name of this type of spheromak: the Electron Spiral Toroid Spheromak (ESTS).

A preferred embodiment of the present invention provides a moving electrode system to initiate an ESTS. One or more electrodes can undergo controlled translation using a programmable control system. A computer can be programmed using software configured to control a data processor or microcontroller to transmit control signals to an actuator that enables motion of the electrodes and to adjust parameters used to form the toroid. The initiating voltage and the current across the arc formed between the electrodes are parameters selectable by the user to control formation and movement. A camera and system sensors can be used to provide feedback control of toroid formation.

This spheromak, the ESTS, is formed using a high current electric arc. The arc is preferably formed in partial atmosphere, and the ESTS is formed around the arc. Instead of forming spheromaks in high vacuum, preferred embodiments of the present invention form them in partial to full atmosphere. The ESTS formed in this manner is observed to remain in place around the arc for the duration of the arc, which has been observed for hundreds of milliseconds.

ESTSs have also been observed to pass through the arc and leave it entirely. When an ESTS leaves the arc, it passes through the magnetic fields of the arc while maintaining ESTS stability and shape. It is observed to remain stable after it is removed from the arc, with no external magnetic field for confinement, and spins at a high rate. High speed cameras have demonstrated that the shape is that of a spheromak by capturing images at a very fast shutter speed, fast enough to capture the ESTS image in mid spin. Also, in cases where the ESTS is removed from the arc, it is observed to endure for hundreds of milliseconds, for example, and can be moved by applying a directed magnetic field.

In a preferred embodiment of the ESTS, the invention provides a class of spheromak that is formed in partial atmosphere in contrast to formation in a high vacuum. This class of spheromak is formed around an electric arc. The spheromak is observed to endure for many milliseconds, a longer time than the tens of microseconds of traditional spheromaks when no external confining magnetic field is used.

A preferred embodiment of the invention includes a method of making a toroid having an ion concentration of at least 10¹⁶ ions/cm³ and preferably in a range of 10¹⁶ ions/cm³-10²⁰ ions/cm³. Such high density ion assemblies can be formed by modulating an arc current in a selected atmosphere at a controlled temperature and pressure. Alternatively, a constant current power supply can be used that can maintain a selected current level during formation of the toroid. Consequently, as current is drawn from the arc to form the toroid, the regulation circuit automatically compensates to maintain the selected current level and thereby achieve the desired ion density in the toroid.

A preferred embodiment uses a sensor system to measure operating characteristics within the system. Different plasma density measuring methods can be used to measure the ion density in the toroid such as Langmuir probes and optical interferometry. With calibration of the measured density signal, the density measurement system can provide a feedback signal to control toroid formation. The sensor system can also measure additional characteristics of the toroid including size and shape and also be used to automate toroid formation and movement. Spectrometers can be used to measure system characteristics or operating conditions such as the gas or reaction products.

In addition to describing the ESTS, described herein is a system for accelerating the ESTS once it has been formed. This enables a user to add energy to the ESTS. The accelerated ESTS has several applications including x-ray generation, particle beam accelerator, or an improved colliding spheromak energy generator. A magnet coil system or an electric field system can be positioned, for example, relative to the arc to move the toroid after formation. A plurality of generators can be used to generate a corresponding number of toroids. One or more accelerators can be used to provide relative movement between generated toroids. In a preferred embodiment, two or more toroids can be generated to interact or collide to cause a reaction and a reaction product.

Preferred embodiments can use one or more magnetic or electric field generating elements to capture one or more ESTS elements after removal of the arc. A containment structure can be used to spatially confine movement of the captured ESTS. A plurality of field-generating elements and containment structures can be used alone or in combination to capture one or more ESTS elements.

### BRIEF DESCRIPTION OF THE DRAWINGS

FIGS. 1A-1B are schematic views of a preferred embodiment of the Electron Spiral Toroid Spheromak (ESTS) invention showing an ESTS formed around an initiating arc.

FIG. 2A is a schematic view of the apparatus used to produce the ESTS with a moving frame used to separate the electrodes.

FIG. 2B is a schematic view of a further preferred embodiment of a system for generating high density charged particle toroids.

FIG. 3 is a schematic view of the apparatus used to produce the ESTS with a screw motor used to move the electrodes in place of the moving frame.

FIG. 4 is a schematic view of the apparatus used to produce the ESTS with a laser used to initiate the arc instead of the moving electrodes.

FIG. 5 is a schematic of the ESTS.

FIG. 6 is a simplified schematic view of an ESTS accelerator.

FIG. 7A is a more detailed view of an ESTS accelerator.

FIG. 7B is a schematic of two ESTS accelerators that can counterpropagate and collide ESTSs in an interaction zone.

FIG. 8 is a process sequence for controlling formation of a toroid using a control system.

FIGS. 9A-9G is a photograph of an arc prior to ESTS formation.

FIG. 10 is a photograph of an ESTS during formation around an arc.

FIG. 11 is a photograph of an ESTS being removed from an arc.

FIG. 12 is a process sequence for controlling ion density in an ESTS during formation.

FIG. 13 is a photograph of a stand-alone ESTS.

FIG. 14 is a photograph of several stand-alone ESTS in relation to a generating electric arc.

FIGS. 15A and 15B illustrate alternative systems for producing stand-alone ESTS in accordance with various embodiments of the present invention.

FIG. 16 illustrates motion of stand-alone ESTS in accordance with various embodiments of the present invention.

FIGS. 17A-17B illustrate several embodiments of the present invention that provide control of the motion of the stand-alone ESTS in accordance with this disclosure.

FIG. 17C illustrates an end view of the embodiment shown in FIG. 17B.

FIGS. 18A and 18B are side and end views, respectively, of a capture system according to various embodiments of the present application.

FIG. 19 illustrates electric field acceleration of stand-alone ESTS in accordance with various embodiments of the present invention.

FIG. 20 illustrates magnetic fields in the vicinity of a stand-alone ESTS.

FIG. 21A illustrates magnetic field acceleration of stand-alone ESTS in accordance with various embodiments of the present invention.

FIG. 21B illustrates an embodiment of the present invention that provides control of the motion of the stand-alone ESTS in accordance with this disclosure.

FIG. 22 is a process sequence for forming, controlling, and manipulating the motion of an ESTS.

### DETAILED DESCRIPTION OF THE INVENTION

A spheromak is a toroidal shaped arrangement of plasma consisting of electrons and ions. A typical spheromak has a toroid shape in a three-dimensional configuration. Additional details regarding prior systems for producing electron toroids can be found in U.S. Pat. No. 6,603,247, the entire contents of which is incorporated herein by reference.

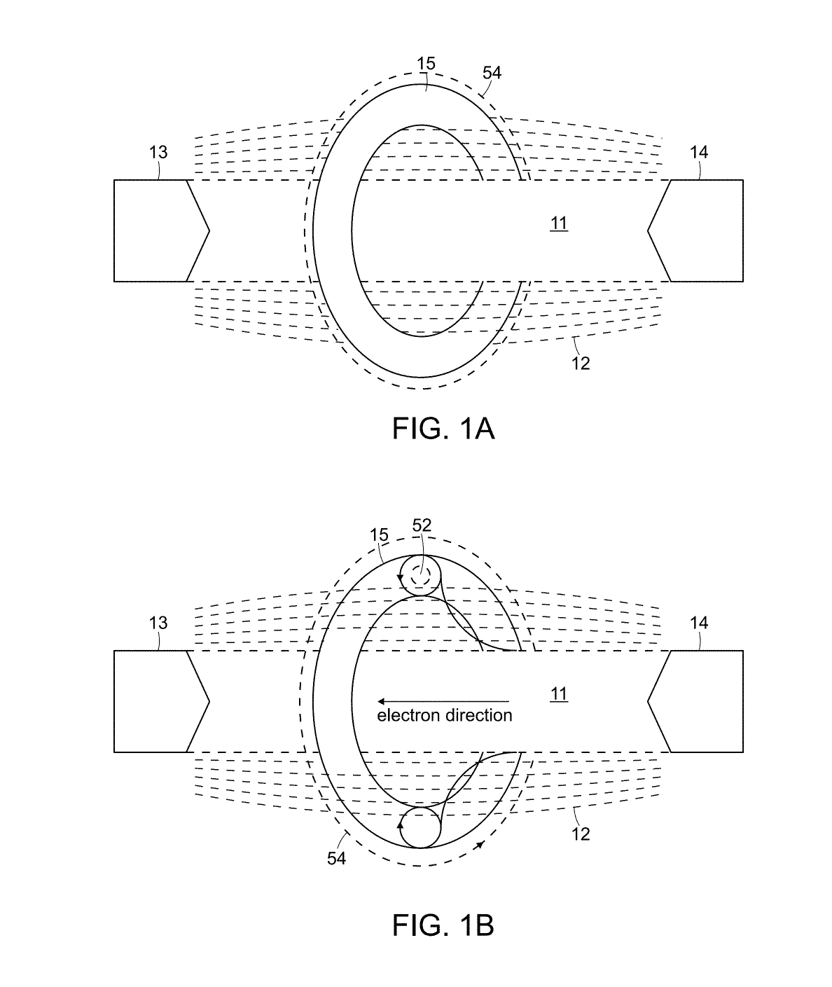

Shown in FIG. 1A is a schematic diagram of a view of a preferred embodiment of the invention. The elements required to initiate an Electron Spiral Toroid Spheromak (ESTS) are an electric arc 11, between an anode 13 and a cathode 14. The arc is formed in partial or full atmosphere in a chamber. The source of the ions 12 can be from the cathode material and/or can be from collisions of the arc electrons with the background gas. When the operating parameters are correct, such as voltage, pressure, arc distance and speed of the moving electrodes, an ESTS 15 forms within the chamber.

The methods for forming an electric arc suitable for formation of an ESTS require stability and duration. The arc must be stable for a period of time, compared to arcs that are often unstable in the sense that they change arc paths rapidly and often.

The arc current value is also important. For arcs of approximately five to eight centimeters of arc length, for example, the current is found to range from 200 to 600 amperes. However, certain applications can utilize currents below or above this range. At this value, the arc has an essentially uniform external magnetic field. As electrons leave the arc, they are acted on by the arc magnetic field which causes them to assume a toroidal orbit around the arc. When enough electrons have left the arc, they produce the ESTS. It is important to note that the arc channel itself must be narrower than the path of the electrons around the arc such that the electrons leave the arc that do not collide with the particles remaining in the arc itself.

Positively charged ions from around the arc and from the cathode are trapped within or around the ESTS surface during formation. These ions serve to electrically neutralize the toroid within the housing. As shown in FIG. 1B, electrons leave the arc and curl around in response to the magnetic field to form the toroid. Electrons and ions can continue to add to the ESTS for as long as the arc remains in place and the ESTS forming conditions are met. The ions situated within the toroid 52 or outside the toroid 54 can form boundary layers with a charge gradient operative to dynamically neutralize a region or envelope around the toroid.

There is a critical point in toroid formation at which the electron velocity within the arc is sufficient and the arc current decreases when field conditions enable toroid formation. With a capacitor system power supply, the voltage across the arc can drop as the arc draws power which results in a decrease in the current. This is coordinated with the increasing distance between the electrodes which increases the resistance between the electrodes. Because the current decreases faster than the decrease in electron velocity, for example, this can enable toroid formation.

More specifically, when the electrodes are employed for initiation in which they are initially touching, the circuit resistance is at its lowest value. At this time, the capacitor power supply can provide a maximum voltage and current when fully charged and can potentially damage the electrodes, for example. To mitigate or eliminate this possibility, a variable resistor or other voltage control device can be used to adjust the initial voltage and current to control the arc and further control initiation of one or more toroids with the arc. In a preferred method, the initial voltage at contact is increased for a first time period upon electrode separation for about 100 milliseconds, for example. However, as the electrode separation increases and more gas particles enter the electrode gap, the resistance in the gap increases causing a reduction in the voltage (and current) across the gap, assuming that the voltage is not increased further by the voltage controller. The exact voltage and current for toroid formation will vary as a function of system resistance, electrode materials, gas pressure, arc gap length and power supply characteristics. In a preferred method, the invention includes a process for generating a plurality of toroids using a single arc sequence. In this embodiment, after formation of a first toroid as described above, the voltage/current across the arc can be reduced to a level that allows the first toroid to be released from the arc. However, the residual arc ions remain in place long enough, even if the arc is temporarily disrupted, for up to a few hundred milliseconds. This enables the system to then increase the voltage/current and reestablish the arc to enable repetitive formation of a plurality of toroids in sequence.

Note that the ESTS has an essentially uniform geometry, that is, the charged particle orbits within the ESTS are nearly the same at all points of the ESTS. This occurs when enough electrons leave the arc and form the essential toroid shape that they in turn create their own magnetic field internal to the ESTS. When this state is reached, then the internal fields in the ESTS ensure that the radius of each orbit is essentially the same for all orbits. At this point the ESTS is stable and is self-organized (that is, confined without an external magnetic field) as described by Chen, C., Pakter, R., Seward, C. in “Equilibrium and Stability Properties of Self-Organized Electron Spiral Toroids,” Physics of Plasmas, Vol. 8, No. 10, 2001, and also U.S. Pat. No. 6,617,775, the entire contents of the publication and patent being incorporated herein by reference. It is also observed to endure in partial atmosphere for hundreds of milliseconds, and as the energy level of the toroid increase, the toroid can endure for minutes. Ions from around the arc are trapped within ESTS surface during formation when the electrons leave the arc and move into the toroid shape, positively charged ions are entrained with the toroid surface.

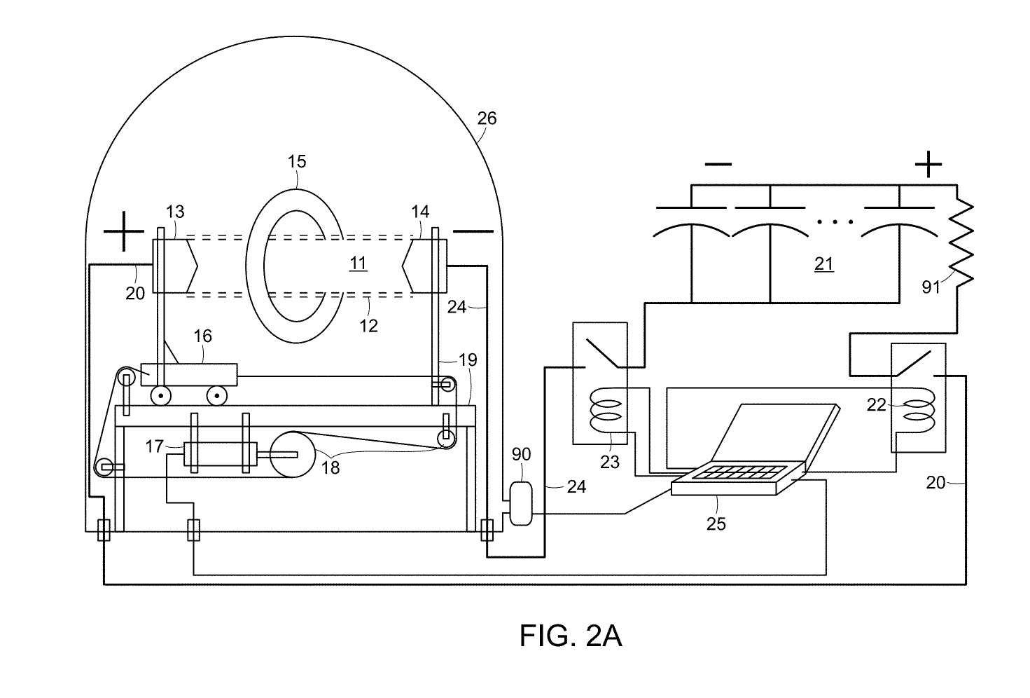

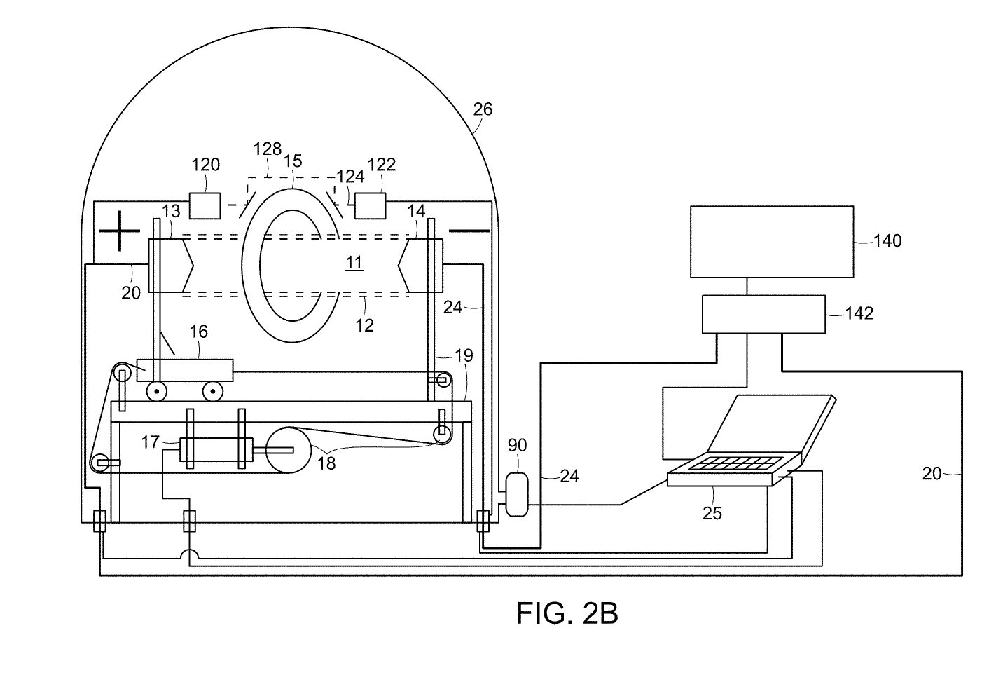

FIG. 2A is a schematic of the initiating apparatus for the ESTS. ESTS formation takes place in a significant atmosphere of background gas, from partial to full atmosphere. The methods for obtaining a partial vacuum are well known such as forming the partial vacuum in a bell jar 26 or other vacuum chamber evacuated using a vacuum pump 90. This operating region can be backfilled with nitrogen to the appropriate pressure. ESTSs forming in pressures from one Torr to 300 Torr were observed, but they can form in higher pressures up to one atmosphere and even higher with selected changes in voltage and spacing. A preferred embodiment operates at gas pressures in a range of 25 Torr to 200 Torr and generates toroids having a density greater than 10¹⁷ ions/cm³.

The electric arc used is formed with electrodes 13 and 14. The arc is formed by first placing the electrodes together then applying voltage enough to maintain the arc across the gap as it is drawn. The electrodes are then drawn apart using the moving frame 16 until the full arc gap is opened, with just the anode on the moving frame, while the cathode is on the fixed frame 19. A motor 17 is used to pull apart the electrodes using a series of simple pulleys 18 and a cable. The fixed frame 19 holds in place the motor, pulleys, and cathode. During the arc drawing process, the arc current can be increased to higher levels which might be harmful to the electrodes when they are touching, but act to increase the arc current later in the process.

Initially, exploding wires were used to generate the arcs. However, the exploding wire needs to be replaced after each event, making difficult ESTS applications which utilize many ESTSs formed in rapid fashion, while the drawn arc approach described herein uses the same electrodes for many arc events. The exploding wires leave a residue which needs to be cleaned and removed after each arc event. Thus the drawn arc system is more useful and efficient for repeated arc formation.

The voltage required across the arc gap is dependent on the gap length, the background gas pressure, and the material used in the electrodes. For a gap length of 8.5 cm, for example, system voltages of 110 VDC to 125 VDC have been shown to produce ESTSs in various pressures. Lower background gas pressures require lower voltages since it is easier to maintain an arc across a gap at lower pressures. Higher voltages have been used also, and there is no upper voltage limit, but as a rule, the voltage has to be low enough to allow electrons to escape the arc.

An electron gun can be used in place of electrodes, except that current electron guns used to produce electron beams do not have the current capability of arcs. Electron guns from Kimball Physics, for example, normally provide maximum currents in the tens of milliamperes range, well below the range needed for ESTS formation. The arcs used in this invention range from a few tens of amperes to thousands of amperes. FIG. 2A shows the power supply, 21, which comprises a capacitor bank. Batteries can be used, as well as other appropriate power supplies. For a preferred embodiment, the arcs range from 200 to 600 amperes, but with specific design requirements, currents below or above this range can be utilized, allowing one to configure the ESTS to fit many applications. To control the current, a variable resistor 91, or similar current limiting device can be placed at the capacitor output.

For the preferred embodiment, the pressure used is preferably about ⅛^{th} atmosphere. The pressure can vary greatly and ESTSs have been observed from 0.10% atmosphere to 36% atmosphere with adjustment of system parameters. The lower limit is the density of the ions that are produced by the cathode material and the background gas as there must be sufficient ions to neutralize the electron charge.

For a preferred embodiment, the measurements of toroid properties can use a background gas of nitrogen, since it is easy to obtain and will not react with the electrodes as they become heated during arc formation. Other inert gases can be used, and argon and helium have been used, for example. Air can be utilized, although it can be harmful to the electrodes since the oxygen can rapidly react with the heated electrodes. Hydrogen can be used, but care must be taken to provide for safety by ensuring that oxygen is not mixed with the hydrogen. Background gases can also include deuterium and pure nitrogen while cathode materials can include boron, carbon, copper, and many other metals.

Referring again to FIG. 2A, the control panel or processor for the arc apparatus is shown schematically as 25, wherein the control panel starts the apparatus by first actuating the contactors 22 and 23 when the electrodes are touching in order to heat the electrodes and to initiate the current. Power is applied to the electrodes using the cables 20 and 24. The controller 25 then actuates the motor to draw the anode 13 and, when conditions are correct, to form the arc and draw it the full length of the arc gap.

There is a limit to how fast an arc can be drawn. If drawn too fast, the arc will extinguish because it will not maintain the arc path. It is desirable to draw fast enough that the ESTS initiates before the capacitor supply discharges enough energy to drop below an output voltage that maintains the arc. Preferably, a draw of 8.5 cm in 0.45 seconds, or about 19 cm/second can be used, however, this value can vary range from 10-50 cm/second.

In one embodiment, the ESTS remains in place as long as the arc remains, which is controlled by the control circuit. In a second embodiment, the ESTS is observed to become self-stable independent of the arc. As the ESTS remains in place, under the right conditions it is observed to increase in density with time. When the ESTS becomes dense enough it is observed to move through the arc and become self-stable in the partial atmosphere. The necessary condition for this to happen is for the internal magnetic field of the ESTS to be greater than the arc magnetic field itself such that the ESTS can cross the magnetic field lines while maintaining its toroidal shape.

To calculate the magnetic field of the arc and the ESTS internal magnetic field, the arc magnetic field is Ba=μ*Ia/2π*Ra, where Ia is the arc current, and Ra is the arc radius. For a typical experiment, with Ia=330 amperes, and Ra=0.0069 m, Ba=0.0097 Tesla.

The ESTS is observed to pass through this field while remaining stable and to do so the ESTS internal magnetic field must be greater than the field of the arc by an approximate order of magnitude (ten times). The ESTS internal magnetic field Bt=Ns*μ*It/2π*Rt, where Ns is the number of electron shells in the ESTS surface, It is the toroidal current in a shell, and Rt is the ESTS radius. For a typical measurement where the ESTS is observed to cross the magnetic field lines of the arc, it is estimated that Ns=25, Is=10,400 A; Rt=0.0137 m resulting in Bt=3.8 Tesla, which is greater than the arc magnetic field.

FIG. 2B illustrates another preferred embodiment of a system for generating an arc that is used to generate a charged particle toroid in accordance with preferred embodiments of the invention. A power source 140 can be used in conjunction with a constant current control system 142 that enables the formation of toroids with a controlled ion density and size.

The toroid 15 characteristics such as size and current density can be optically measured using interferometry in which a light source 120 transmits a light beam 124 and a detector system 122 detects light that is transmitted through the arc. Size and geometry can also be measured using CCD or CMOS imaging camera. A reference beam 128 can be separated from the beam transmitted (or reflected) through the arc using a beamsplitter. The reference beam 128 and transmitted beam 124 can be combined with a second beamsplitter. A change in the phase relationship between the transmission beam 124 and the reference beam 128 is correlated with the ion density.

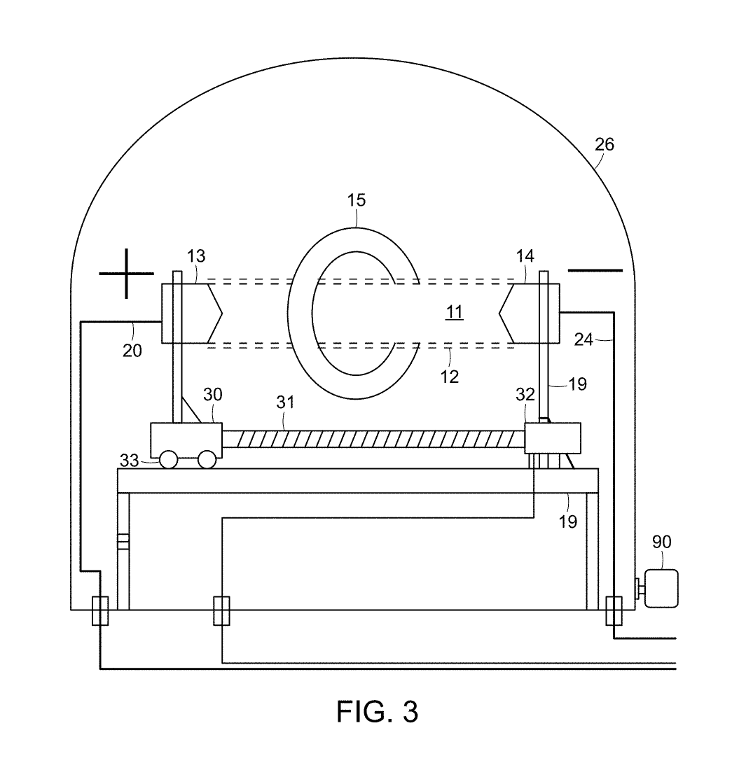

FIG. 3 shows a further improvement to the apparatus for drawing the arc. In this embodiment the moving frame and motor used to draw the arc are replaced by a simple screw and motor arrangement to move an electrode. Referring to FIG. 3, the anode is mounted to a moving frame 30. The moving frame is attached to a long screw 31 that is turned directly by a motor 32. As the motor is made to turn in one direction, it moves the moving frame away from the motor, thus drawing the arc. Similarly, as the motor is made to turn in the opposite direction, it moves the moving frame toward the motor and thus makes the electrodes touch in order to start another arc event. On the moving frame are shown wheels 33 used to maintain the orientation of the moving frame such that it remains level as the screw turns. Note that metal features are shielded from the arc in order to prevent the arc from finding an unintended ground and jumping from its intended arc path.

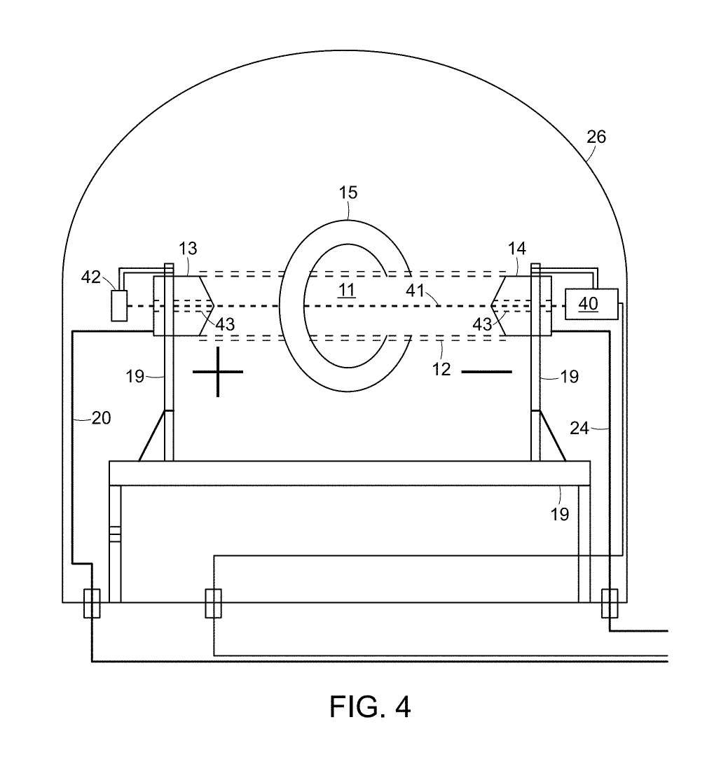

FIG. 4 shows a further improvement to the apparatus for drawing the arc. In this embodiment, the moving frame and motor used to draw the arc are replaced by a stationary laser that is used to ionize the background gas so as to establish an ion path from anode to cathode, which causes the voltage between electrodes to establish a current path and therefore an arc between the electrodes. Referring to FIG. 4, the anode is mounted to the stationary frame 19. A laser generator 40 is attached to the stationary frame such that its laser path 41 will travel through the cathode 14 and then through the anode 13 to hit the laser target 42. Note that the electrodes each have a hole through their center 43 to allow the laser to pass through. The laser causes the background gas to ionize and in so doing, allows the electric arc to form without the need for drawing the arc. Note that the laser generator and laser target must each be insulated from the anode and cathode in order to prevent the arc from finding them as an unintended ground and jumping from its intended arc path.

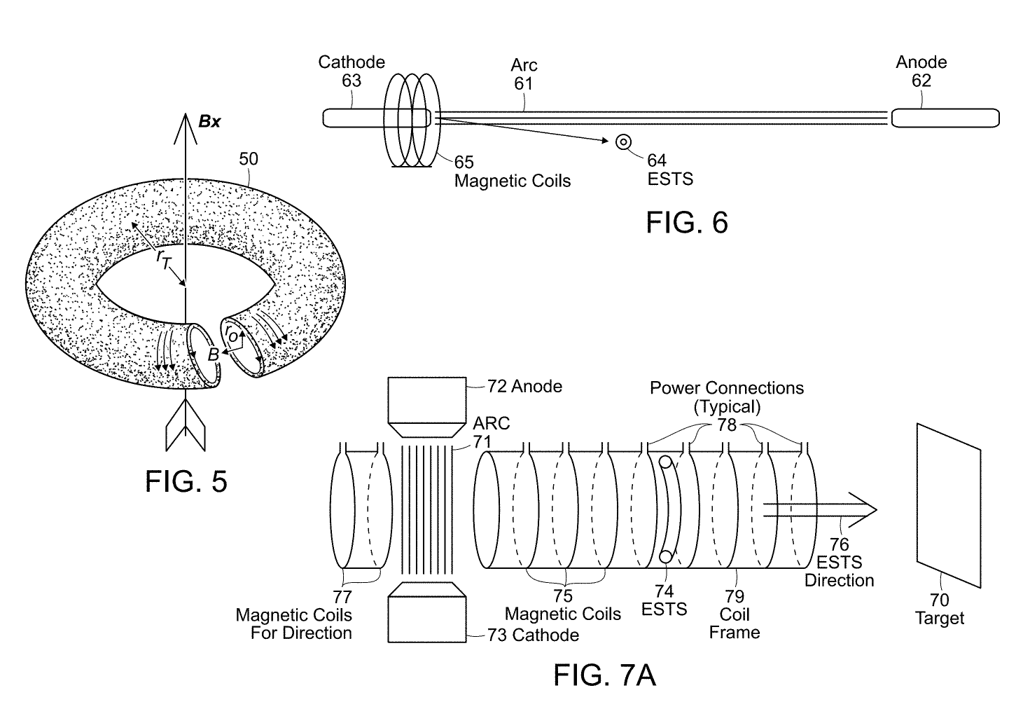

FIG. 5 is a schematic view of the ESTS 50 as a stand-alone entity. It shows the typical toroidal shape of the spheromak, and the hollow center of the ESTS. The internal magnetic field is shown as B. The radius of the orbit of the charged particles is r_{O} and is essentially uniform for all charged particle orbits. The radius of the ESTS is r_{T} and is essentially uniform for the entire ESTS. The electron shell is shown in a dotted manner as the outer shell. The spiraling of the electrons is shown by the parallel arrows, showing that the electron paths are parallel as the electrons spiral around the toroid. Also shown schematically is a continuous shell, representing the internal ions that neutralize the electron space charge, noting that external ions are observed as well, and can contribute to neutralizing the space charge. Calculations show that the model supports many shells of electrons and shells of ions. Also shown is the external magnetic field of the ESTS, labeled Bx, which results from the current caused by the spiraling motion of the charged particles in the ESTS. This external magnetic field is much less in magnitude compared to the internal magnetic field, but is important because it allows the ESTS to be transported and accelerated.

With this level of detail visible it is important to point out that during the initiation of the ESTS as shown in FIG. 1, the radius of the ESTS is greater than the radius of the initiating arc by an amount such that the orbit radius of the particles does not collide with the arc itself. This is helped by the background gas which acts to produce a narrow arc channel.

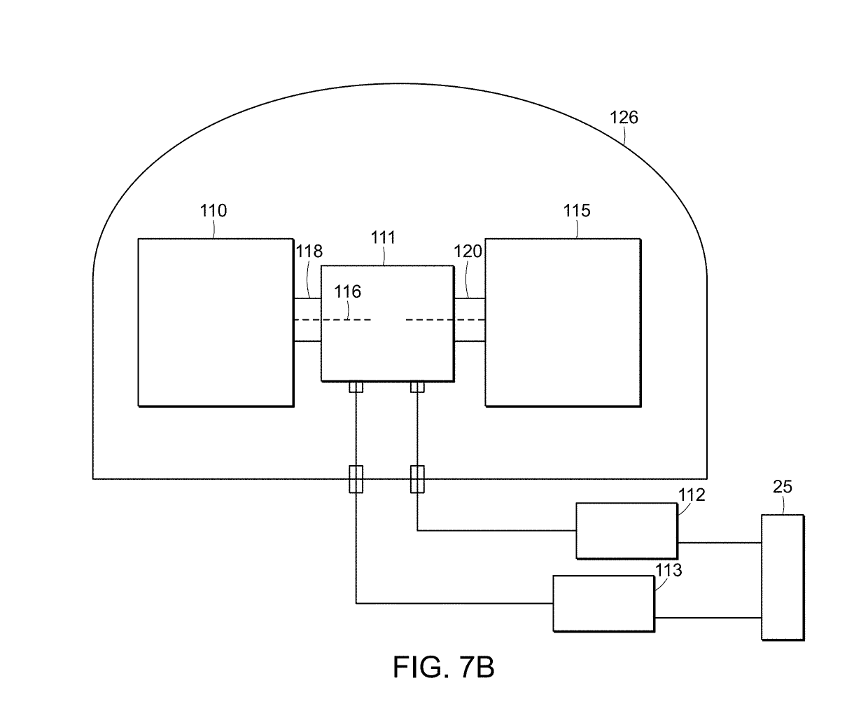

FIG. 6 is a simplified schematic diagram of an accelerator for the ESTS. The system enables small ESTSs in arcs that moved in random directions along the arc path or out of the arc path. Measurements and analysis have showed that they were self-organized and stable as described above and in the references, and that they could pass through the magnetic fields of the arc while retaining their shape. They are typically of small diameter of 0.2 cm to 0.5 cm. They were observed to form directly at the cathode or sometimes at the anode. Their size is consistent with the hot spots which form on the anode or cathode and from which the arc is seen to emanate. An electric arc consists of an accumulation of small arcs that form at individual hot spots, which explains how small ESTSs form during a larger arc event.

For clarification, an arc formed between the anode and cathode can comprise many smaller arcs that form at the many hot spots on the cathode and also on the anode. This phenomenon is described in greater detail in Boxman's “Handbook of Vacuum Arc Science and Technology,” the entire contents of which is incorporated herein by reference. These small arcs form and then dissipate within the larger arc as the hot spots in turn become too hot to maintain them. Small ESTS form around these small arcs and are then released when the small arcs extinguish. The small ESTS then pass out from within the larger arc, crossing the magnetic field lines of the larger arc while maintaining their shape.

Further measurements demonstrated that these small ESTSs can be accelerated using magnetic coils or electric fields. FIG. 6 shows the arc 61 formed between an anode 62 and a cathode 63. Under the right conditions of pressure, voltage, and current, many small ESTSs 64 were observed. Electric fields will accelerate the ESTS. When magnetic coils 65 were added and energized, the ESTSs were observed to accelerate. When accelerating the ESTS, care must be taken to keep the accelerating magnetic field below the level of the internal magnetic field of the ESTS or else the ESTS itself will lose its shape and stability, and can dissipate.

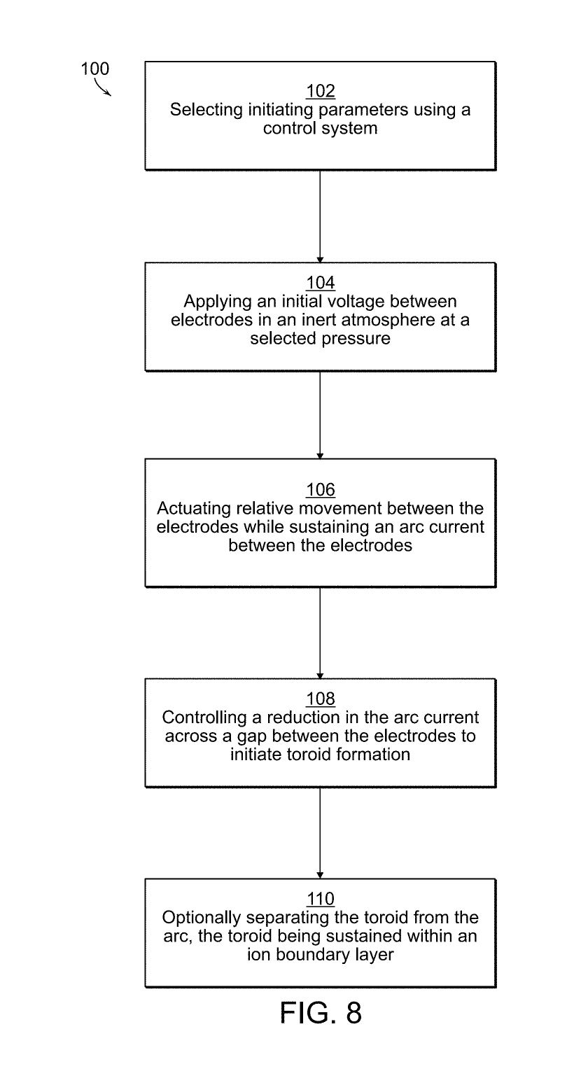

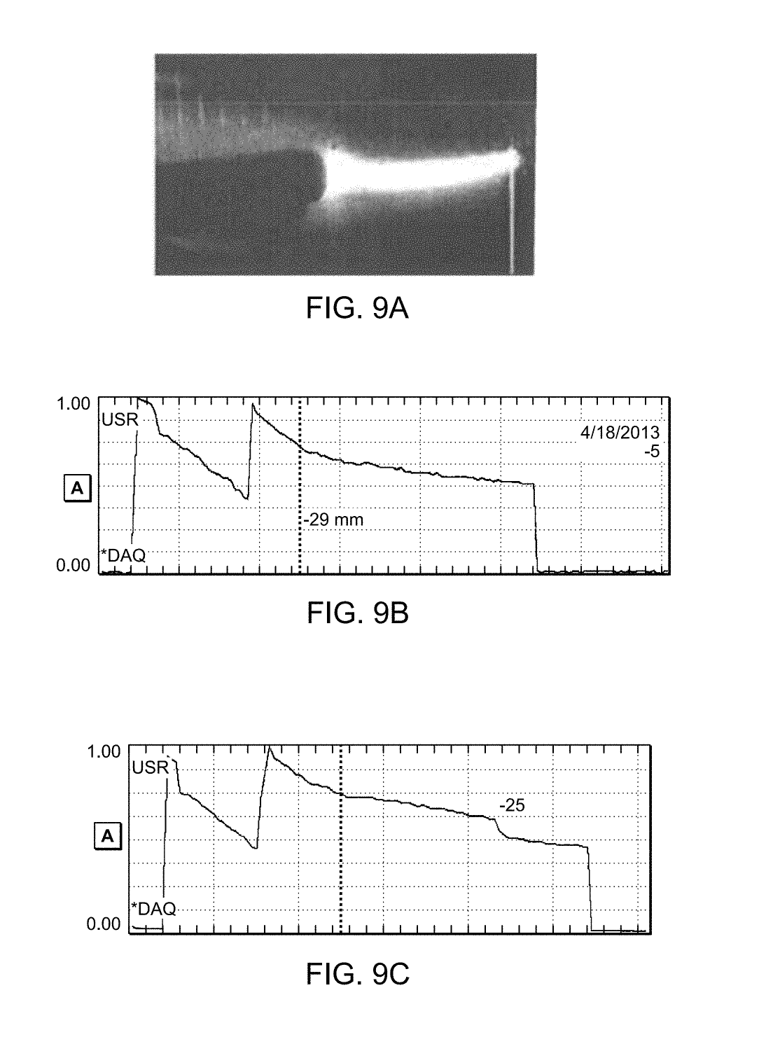

FIG. 7A illustrates that the ESTS is formed by an arc 71 formed between the anode 72 and the cathode 73. As described above, the ESTS 74 forms under appropriate conditions of voltage, current and pressure. Magnetic coils 75 accelerate the ESTS in the direction shown 76 when energized with a selected current. Magnetic coils for direction are shown as 77 to direct ESTSs once they are formed in the arc. Power is connected to individual coils of the magnet coil assembly with power connections 78. A frame 79 for holding the coils in place that can optionally be located inside the coils and made of a material such as ceramic which will help to guide the ESTS during its acceleration. A target, shown as 70, has various purposes depending on the application. The power supply for the coils and the control circuits to turn the coils on in succession to accelerate the ESTS are also known.

The basic equations for a solenoid magnetic field accelerator of an electron spiral toroid spheromak using an applied magnetic field pulse are presented here. Measurements have shown that when a static magnetic field is applied, accelerations of the ESTSs up 6000 m/s² have been observed. The theory of self-organized ESTSs has been developed to describe the confinement and stability of self-organized EST's.

Consider the magnetic coil ESTS accelerator shown schematically in FIG. 7A. For simplicity, let us make the following assumptions:
(a) The power supply is characterized by its capacitance C and inductance L.
(b) The solenoid wires are perfect conductors.
(c) The ESTS internal magnetic (self-magnetic) field is much greater than and orthogonal to the applied magnetic field produced by the solenoid.
(d) The EST has such a high conductivity that it shorts the circuit.
   Under these assumptions, the entire system can be treated as a circuit consisting of the power supply and the solenoid shorted by the ESTS. The circuit equation for the system is

$${L}_{T} ( z ) \frac{{d}^{2} I}{{dt}^{2}} + \frac{I}{C} = 0 , \qquad ( 1 )$$

where L_{T}(z) is the total inductance of the system, and I is the current flowing down the solenoid. Let dL₀/dz be the inductance of the solenoid per unit axial length, and then the total inductance can be expressed as

$${L}_{T} ( z ) = L + ( \frac{d {L}_{0}}{dz} ) z , \qquad ( 2 )$$

where we have assumed that the solenoid starts at z=0 and z is the axial position of the center of the ESTS. The equation of center-of-mass motion of the ESTS can be derived from magnetohydrodynamics (MHD) (Schmidt, 1979). To summarize, the self-consistent equations governing the ESTS acceleration are

$$\begin{matrix}{L}_{T} ( z ) \frac{{d}^{2} I}{{dt}^{2}} + \frac{I}{C} = 0 , & ( 3 ) \\ {L}_{T} ( z ) = L + ( \frac{d {L}_{0}}{dz} ) z , & ( 4 ) \\ M \frac{{d}^{2} z}{{dt}^{2}} = \frac{1}{2} ( \frac{d {L}_{0}}{dz} ) {I}^{2} , & ( 5 )\end{matrix}$$

where M is the ESTS mass. These coupled equations can be solved simultaneously to predict the trajectory of the ESTS. It should be noted that equations (3)-(5) have the same form as those obtained and verified (Hammer, et al., 1988) for the compact toroid accelerator reported by (Hammer, et al., 1988; Degnan, et al., 1993; Kiuttu, et al., 1994).

FIG. 7B shows a further embodiment containing a plurality of the ESTS-emitting systems 110, 115 shown in FIG. 7A and also including system features described in connection with other figures such as a density measurement system as shown in FIG. 2B. In this embodiment, two systems are positioned such that the ESTSs emitted by each system are directed towards the other along axis 116 in a manner to allow collisional contact among ESTSs emitted from one system and ESTSs emitted from the other. This collision occurs in a spatial region 111. In a preferred embodiment, the background gas atmosphere inside the vacuum chamber 126 comprises a partial pressure of deuterium. When parameters such as gas pressure and initiating voltage are chosen correctly, the resulting ESTSs have very high charged particle densities of over 10¹⁶ ions/cm³ and preferably over 10¹⁷ ions/cm³. When very high density ion toroids containing deuterium collide, helium is produced. The interaction area or region 111 optionally contains or couples the region 111 to sensors such as a mass spectrometer 112 or optical spectrometer 113 that can observe and record data related to the collisional contact between opposite-traveling ESTSs. For example, a mass spectrometer such as the MKS-835 produced by MKS Instruments can be used. The mass spectrometer 112 can be used to detect the presence of helium or other elements present in the chamber while the optical spectrometer 113 can be used to detect emissions from component elements or molecules in region 111 such as a helium spectral emission line at 5850 Angstroms, for example. The spectrometer systems 112, 113 can generate data delivered to data processor 25, display, and data storage devices. Based on the measured data, the processor can be programmed to adjust parameters for operation of systems 110, 115 to match or adjust the size, density, and acceleration of the pair of ESTSs that interact in region 111. Valves 118, 120 can be used to control the flow of gas and ions between systems 110, 115 and region or chamber 111. Additional valves and pumps can be used to control gas delivery to all the systems jointly or separately.

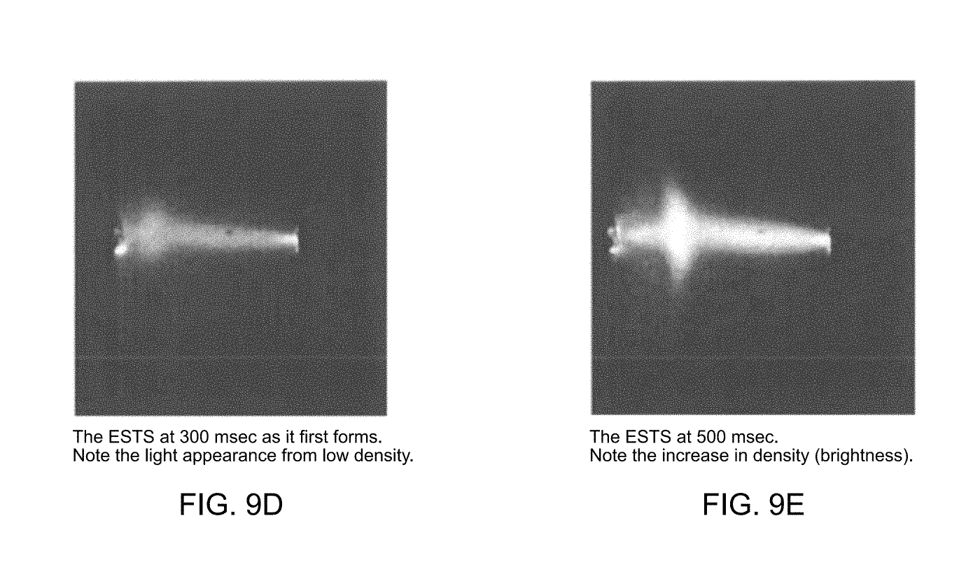

Illustrated in FIG. 8 is a process sequence 100 in which a programmable control system is used to initiate a toroid. Software is used to issue instructions to system components to control timing of arc formation. The process is initiated when the user selects parameters 102 such as electrode spacing separation velocity, gas pressure and initiating voltage 104. Actuators are instructed to provide for movement 106 of one or both electrodes to increase the gap. The arc current is reduced or attenuated in a controlled manner such that a toroid forms 108. The toroid can optionally be removed 110 from the arc by selective modulation of the arc and magnetic field conditions. The toroid formation process can optionally be repeated as described herein.

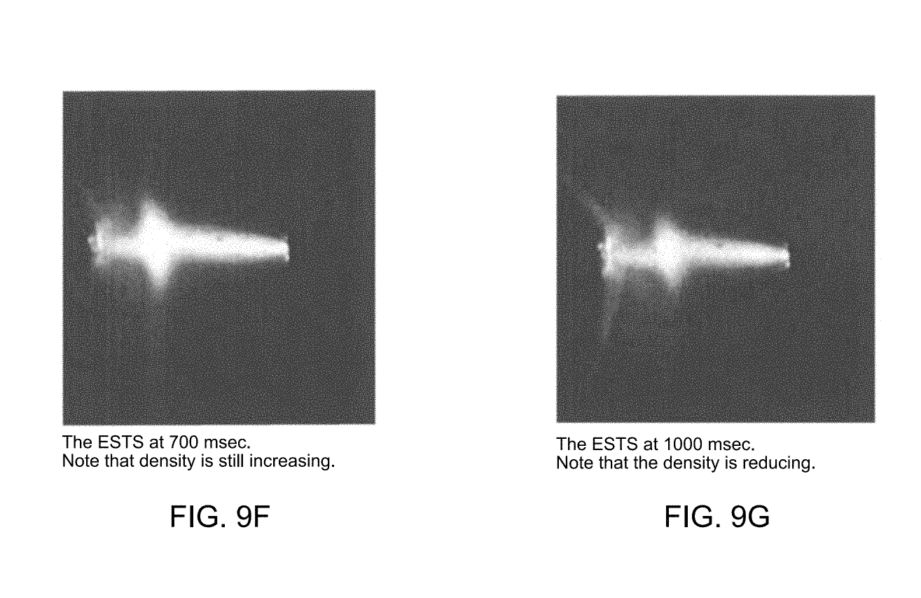

Shown in FIG. 9A is a photograph of an arc used for initiation of the toroid. The measurement of the density of the ESTS gave a value greater than 10¹⁷ ions/cm³ with no externally applied confining toroidal magnetic field. Note that the formation of the ESTS caused a significant change in the current of the arc. FIG. 9B shows the normal arc current characteristic when no ESTS is present. The power supply is capacitive as described previously herein and exhibits an exponential curve. For explanation, the trace shows the characteristic of a drawn arc, with the electrodes touching at the start, the drawing apart, and, at approximately 360 msec, a significant increase in current. This dual current approach can be used to protect the electrodes at the start of the event. FIG. 9C demonstrates that the arc current undergoes a significant change occurring at the time that the ESTS forms. This change in current is measured as 5 mm on this trace, but because three power supplies are used to reach the current required, and three traces are made during each event, the total current is measured as 18.4 amperes for 40 msec, or 0.737 Coulombs of charge per 40 msec. This current goes directly into the ESTS, which is consistent with the video observations. Because this is a charge neutral assembly of positive ions and electrons, no magnetic confinement is needed to hold this charge in place.

The measurement example ends at approximately 1,080 msec. In this case, the ESTS was still forming at 200 msec at the end of the measurement, for a full charge of 3.68 Coulombs.

The density of the ESTS can be estimated using this initial estimate of charged particles. The ESTS volume is calculated as 7.7×10⁻¹⁷ m³ with a toroid radius of 0.00625 m and orbit radius of 0.0025 m. Density is the electrons/volume calculated as 2.98×10²⁵ electrons/m³ or 2.98×10¹⁹ electrons/cm³ in this example. Because the number of positively charged ions and electrons has to be essentially equal to ensure charge neutrality, the ion density is the same as the electron density, or 2.98×10¹⁹ ions/cm³. The computer model calculates the density as greater than 10¹⁷ ions/cm³ and supports densities greater than 10¹⁹ ions/cm³.

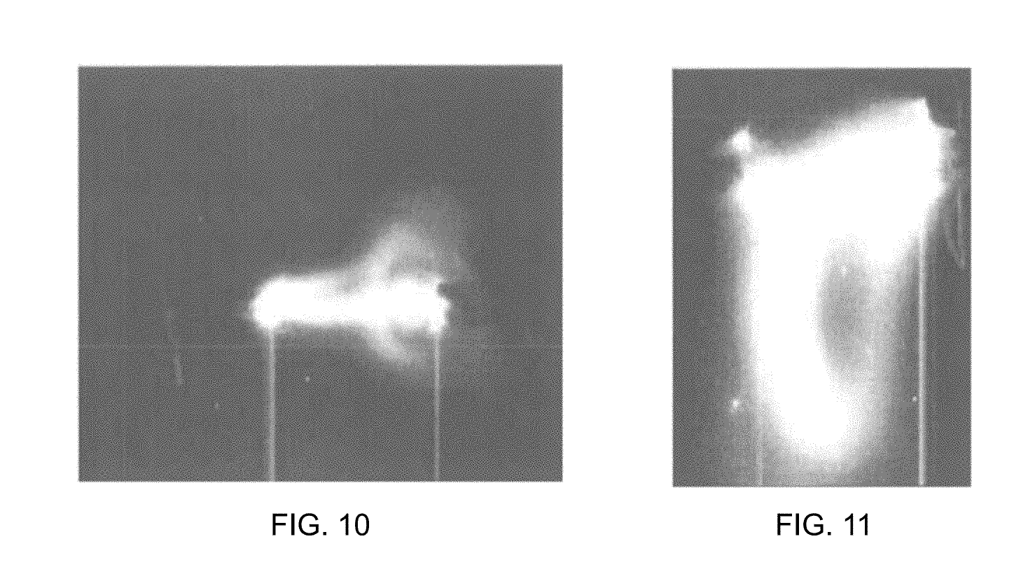

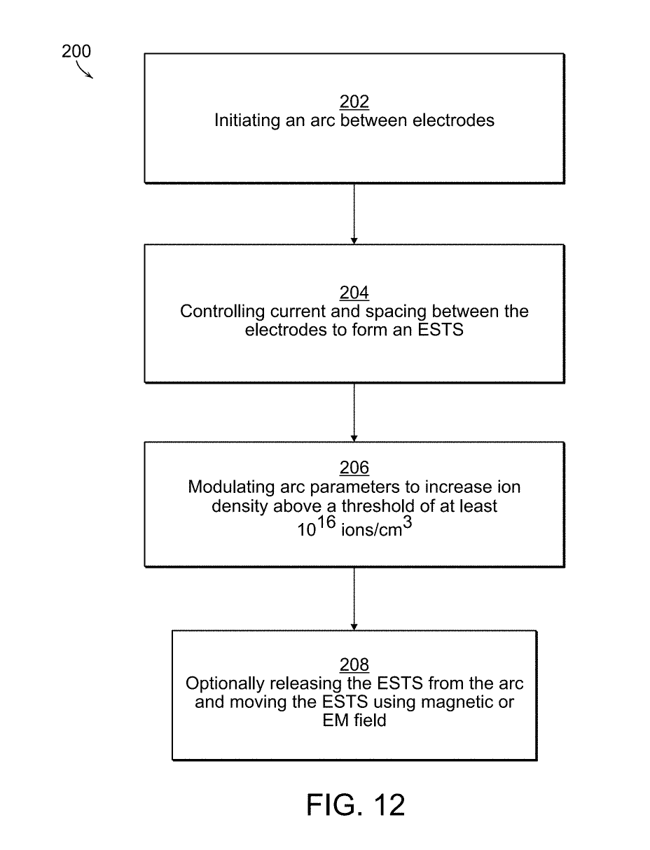

FIGS. 9D-9G show the ESTS at different times during the formation sequence. It is a side view only, and the shape is a band rather than the more characteristic toroidal shape of FIGS. 10 and 11. These figures show the increasing density with time, which appears visually as increased brightness. The density reduces late in the measurement as the power supply discharges and is unable to maintain the conditions necessary to increase the density. With a longer initiation time, the density will increase above the critical density needed to remain stable.

The observed data relative to the ESTS in FIG. 10 demonstrate the ESTS equilibrium of forces. The radius of the toroid in FIG. 10 is observed as 0.033 m, and the radius of the electron orbit is observed as 0.0066 m, resulting in an overall diameter of 7.9 cm, with an aspect ratio of 5:1. The pressure is 0.125 atmospheres of nitrogen. The electron energy in the surface of the ESTS is estimated as 10⁻⁶ eV with electron velocity of 593 m/s. Generally, it is advantageous to have a diameter of the toroid in a range of 2 cm-8 cm.

In analyzing this system, a first assumption is that the electrons are equally spaced, providing a geometric ratio of orbit distance to electron distance of k_{O}=0.87. Second, the model also assumes an ion fraction utilized in the estimate of 1.001. Finally, dₑ and dᵢ are assumed to be close, with dᵢ smaller by the ion fraction. Because the background pressure provides the restoring force, dₑ is calculated as 7.69×10⁻⁸ m, at which value the forces within the ESTS are in equilibrium.

The initial model demonstrated equilibrium for an electron surface of a single electron shell a single electron thick, and similarly, an ion surface a single ion thick. The reason for this one shell was a tacit assumption that the ESTS contained only particles captured within the ESTS volume at time of formation. However, observations suggest that this limitation is too restrictive. The ESTS forms around the arc and is seen to continue to accumulate charged particles for as long as initiating conditions remain in place, observed for a few hundreds of msec, for example.

The model has been extended here to an ESTS with multiple thin shells. This suggests that an electron shell is the outermost surface, with an ion shell next, then an electron shell, then an ion shell, and so forth. The alternating electron and ion shells can maintain charge neutrality. This series of shells can continue to accumulate as long as the force balance remains in equilibrium, which by this model is limited by the total internal magnetic field strength because it increases with the increasing number of shells.

The balance of forces holds for each shell. In addition, the number of shells sets the overall limit to the number of charged particles by setting the limit to the internal magnetic field, which acts to repel electrons. The example analyzed here achieves the balance of forces up to a maximum of 486 shells, and a total of 2.67×10⁻¹⁰ Coulombs of charged particles. The internal magnetic field at these values is 6.09 Tesla, using the formula for a closed solenoid. The equations above have been incorporated into a computer model of the ESTS.

The ESTS in FIG. 11 is observed to endure in ⅛ atmosphere of nitrogen before passing out of the field of view of the measurement. Pressures are preferably in the range of 1/16 atmosphere to ½ atmosphere. ESTSs formed by an arc and leaving the arc are normally spinning rapidly after initiation. In FIG. 11 the spinning has been effectively slowed using a high-speed video camera at 1/10,000 second shutter speed.

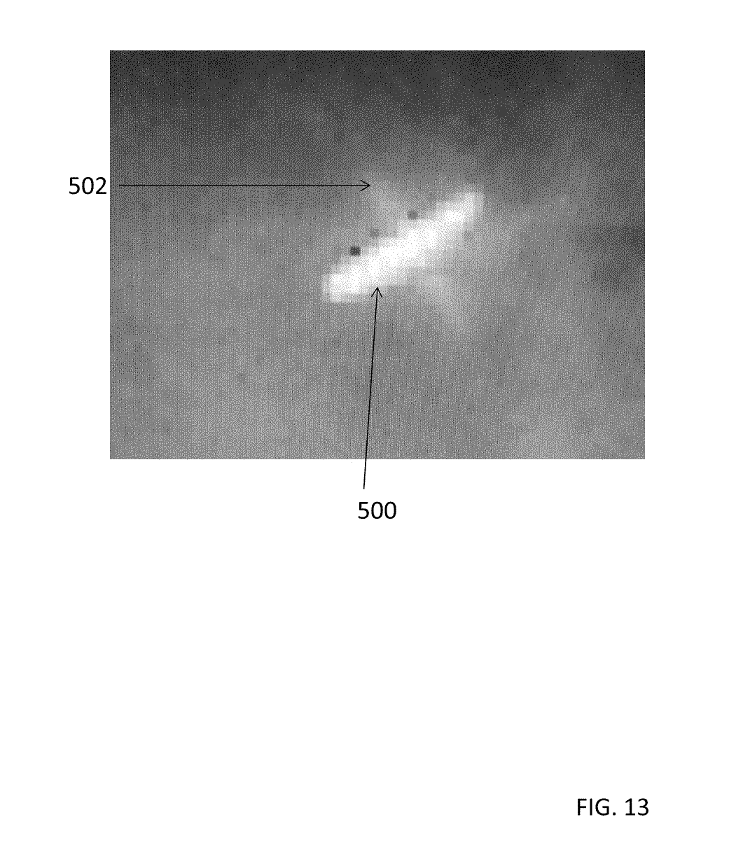

The arc system described herein enables large, high density ESTSs that are 8 cm in diameter or larger, for example, as shown in FIG. 10 and FIG. 11. First, it was necessary to form stable arcs of high energy, which was done as shown in FIG. 9A. The arcs accommodated currents in a wide range, from hundreds of amperes to a few thousand amperes. The arc current can be regulated as shown in FIGS. 9B and 9C, which show current level between the electrodes as a function of time. The current can be stepped or modulated after the electrode spacing reaches an initiation distance. As shown in FIGS. 9D-9G, in this example photographs show the growth of the ESTS at 300 msec, 500 msec, 700 msec and 1000 msec. The density peaks as charge is added to the ESTS at a rate that exceeds the decay rate. As shown in the process flow diagram 200 of FIG. 12, the ion density of the ESTS can be formed to exceed a threshold prior to release from the arc. After initiation of an arc current 202, the current and spacing between the electrodes is controlled 204. By adjusting the arc parameters 206, a toroid having an average ion density above a threshold of at least 10¹⁶ ions/cm³ can be obtained. A magnetic field can be used to move 208 the toroid after formation.

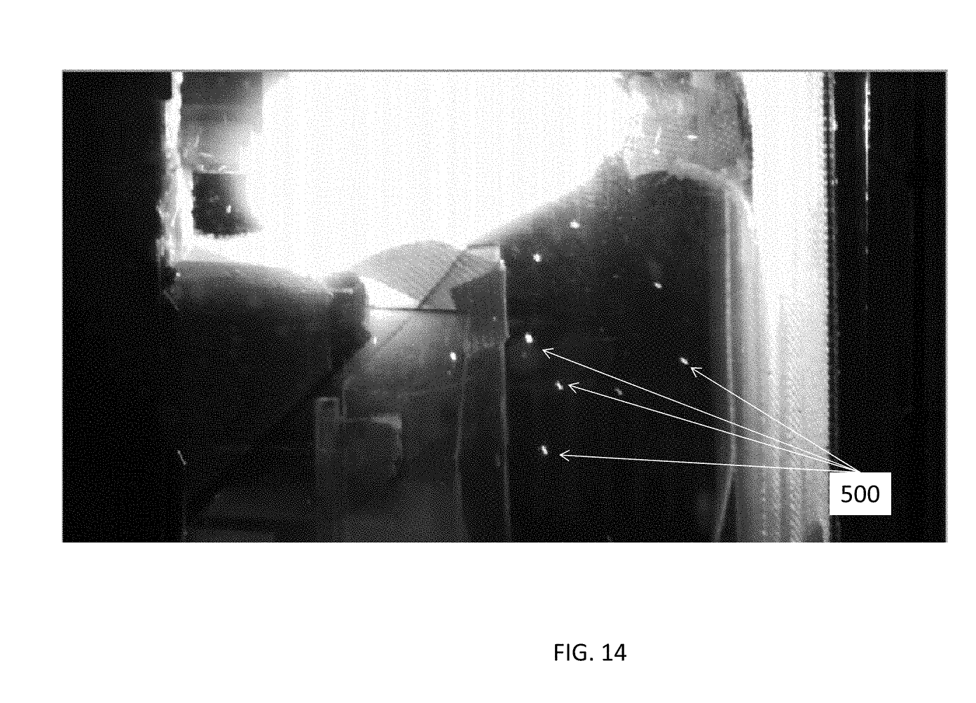

By optimizing parameters, it is possible in some cases to produce separated electron spiral toroids. FIG. 13 depicts a single ESTS 500 that has been trapped in external magnetic fields in a horizontal orientation. In this image, the toroid appears to be at an angle of thirty degrees because of the orientation of the camera capturing the image; the single ESTS is in fact oriented horizontally. The light vertical line 502 emanating through the center of the stand-alone ESTS 500 is the polar magnetic field of the toroid, and the line is colored blue because of interactions with the nitrogen background gas.

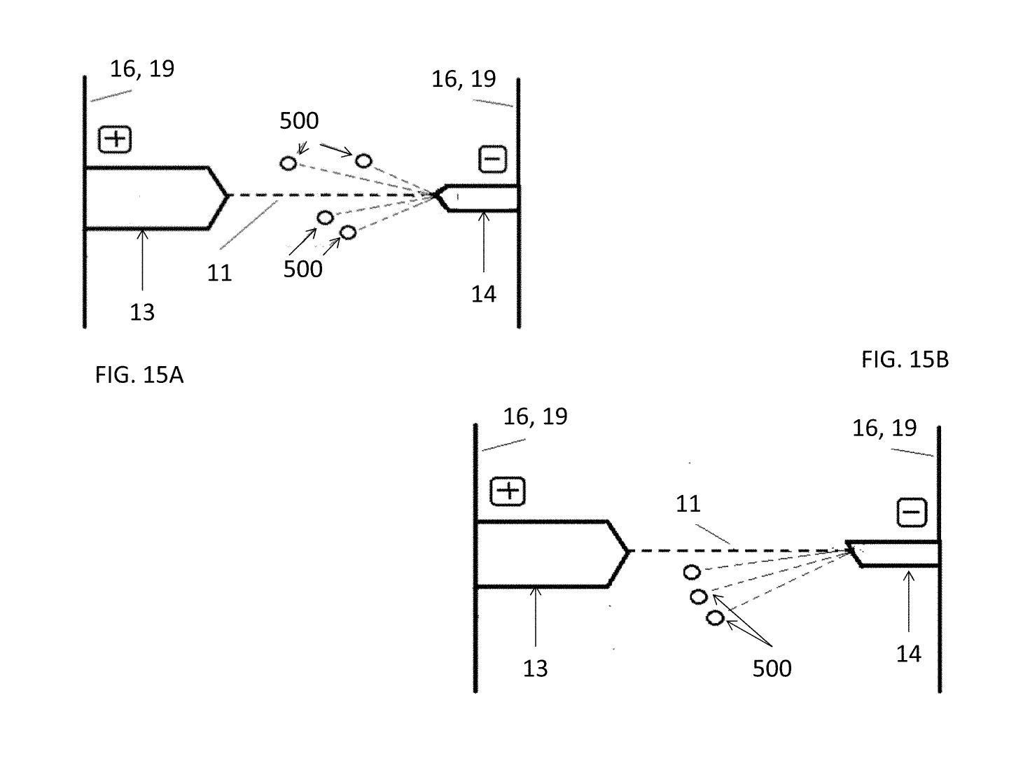

FIG. 14 depicts clusters of small separated ESTS 500 below an arc. The ESTS 500 can exhibit a number of interesting properties. For example, the separated ESTS elements 500 can bounce off of solid walls and retain their shapes. Conversely, a smoke ring plasma can collide with a wall and dissipate rather than bounce off. The elastic collision behavior of the separated plurality of ESTS elements 500 with respect to walls is in indication of the high density of the stand-alone ESTS.

A very high resolution (e.g., 1024×1024 pixels) and high frame rate (e.g., up to 5,400 frames per second, up to 20,000 frames per second, up to 67,500 frames per second, or up to 675,000 frames per second depending upon resolution) camera (Fastcam SA1.1, Photron, San Diego, Calif.) was used to measure the ESTS. A series of lenses and light filters was used to optimize viewing depending upon the measurement being run. In accordance with various embodiments of the present application, the ESTS can be produced using pressures in a range from 1 Torr to 10 Torr. However, pressures greater than 10 Torr and less than 1 Torr can also be used to successfully create ESTS elements. In some embodiments, the diameter of each ESTS can be in a range from 0.5 to 10 millimeters although there is no theoretical upper or lower limit. In an exemplary embodiment, the diameter of each ESTS can be 1.3 millimeters. In some embodiments, the ESTS can remain stable in partial atmosphere for tens of milliseconds even after the arc has been turned off such that no external magnetic forces exist in the vicinity of the ESTS. This stands in contrast to previously described plasma toroids, which have typically required external fields to maintain integrity and dissipate in a few microseconds.

The ESTS can evolve through different phases over time. In an initial phase, each ESTS can be rapidly spinning and extremely bright with the appearance of a sphere. In this phase, the ESTS elements are spinning too rapidly to be captured using a weak magnetic field or to be analyzed by simple imaging technology. In a later phase, the ESTS can lose rotational energy and velocity as they bounce, but they maintain their shape. As a result, the ESTS can be captured mechanically and oriented through use of a magnetic field and/or electric field.

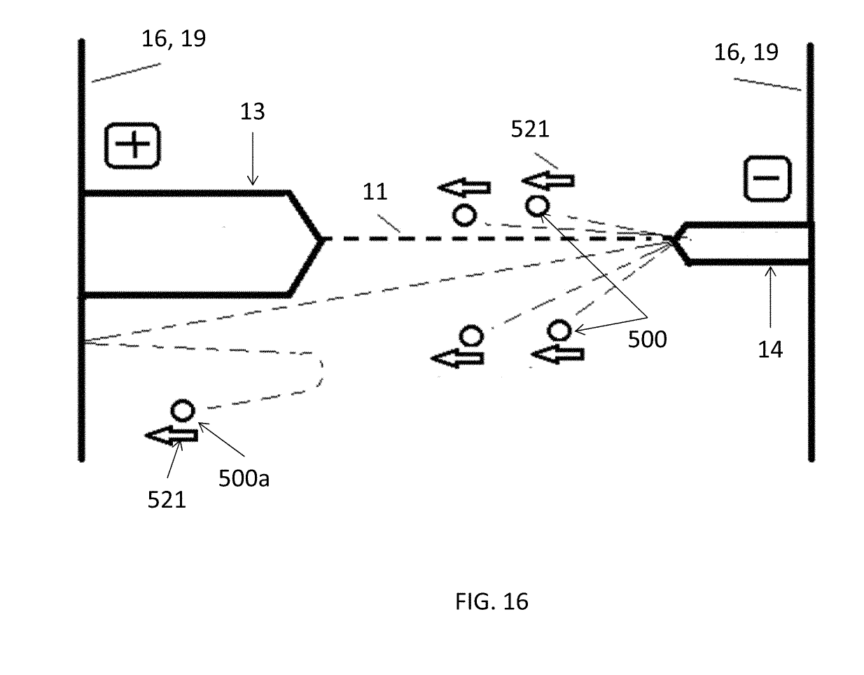

FIGS. 15A and 15B illustrate alternative embodiments of a system for generating separated ESTS 500 after arc termination. The system can include an anode 13 and a cathode 14 that generate an arc 11 between them as described above with reference to FIGS. 1A and 1B. In the figures, the dashed lines leading to each ESTS illustrates its trajectory. In accordance with various embodiments, the ESTS elements 500 are preferentially emitted in a direction perpendicular to a surface of the cathode 14. Notably, the ESTS elements 500 can be formed outside the arc 11 or, if formed surrounding the arc 11, can travel nearly immediately after formation outside the arc 11. FIG. 15A illustrates an embodiment of a system for generating ESTS elements 500 including a cathode 14 that has a symmetrically angled surface around a center point. The symmetrically-angled cathode 14 can emit ESTS 500 in a cone through a full 360° around the center point.

As shown in FIG. 15B, the cathode 14 can be shaped to have a single surface angled with respect to an axis along the length of the arc, i.e., the axis extending from anode 13 to cathode 14. In some embodiments, the angle of the single angled surface of the cathode 14 can be 5 degrees, 20 degrees, 45 degrees, 60 degrees, or any other suitable angle as needed for specific applications. By using a single angle surface on a face of the cathode 14 rather than a two- or multi-surface end such as that shown on the anode 13 in FIG. 15A, a larger portion or substantially all of the ESTS elements can be emitted at trajectories near the preferred trajectory. It will be appreciated that the two end surfaces of the cathode 14 illustrated in FIGS. 15A and 15B are not the only shapes that the surface can take and that other surface shapes may be useful.

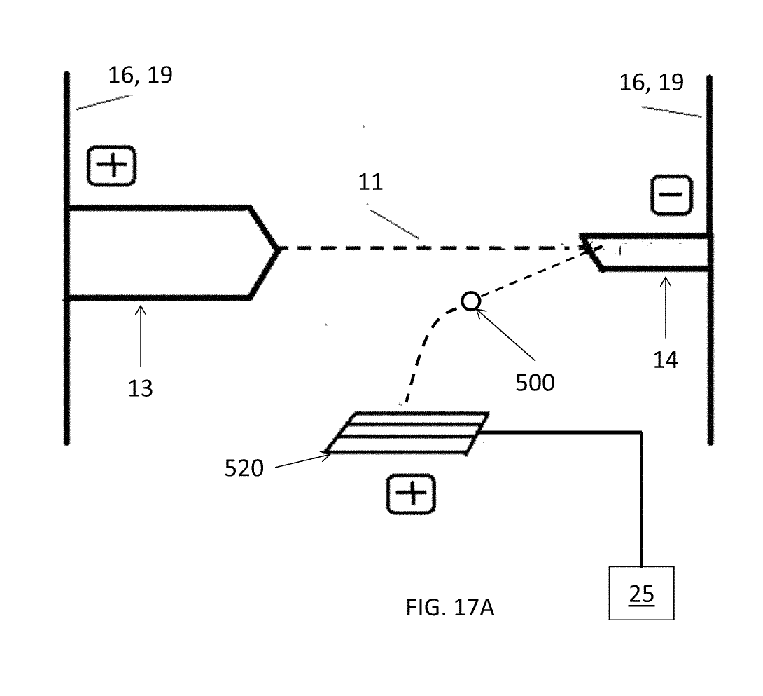

FIG. 16 illustrates in greater detail the motion of ESTS once they begin to travel away from the arc 11. As the ESTS elements 500 leave the cathode 14, they are accelerated in a direction 521 towards the anode 13 by the electric potential between the anode 13 and cathode 14. As the group of ESTS elements reach the frame 16, 19 supporting the anode 13, individual ESTS 500a can bounce off of the frame 16, 19 near the anode 13 and briefly travel backward in the direction of the cathode 14. However, the electric field can then act to turn individual ESTS 500a back in the direction 521 towards the anode 13 as shown. In some embodiments, the electric field can range from 100 VDC/0.01 m to 80 VDC/0.055 m.

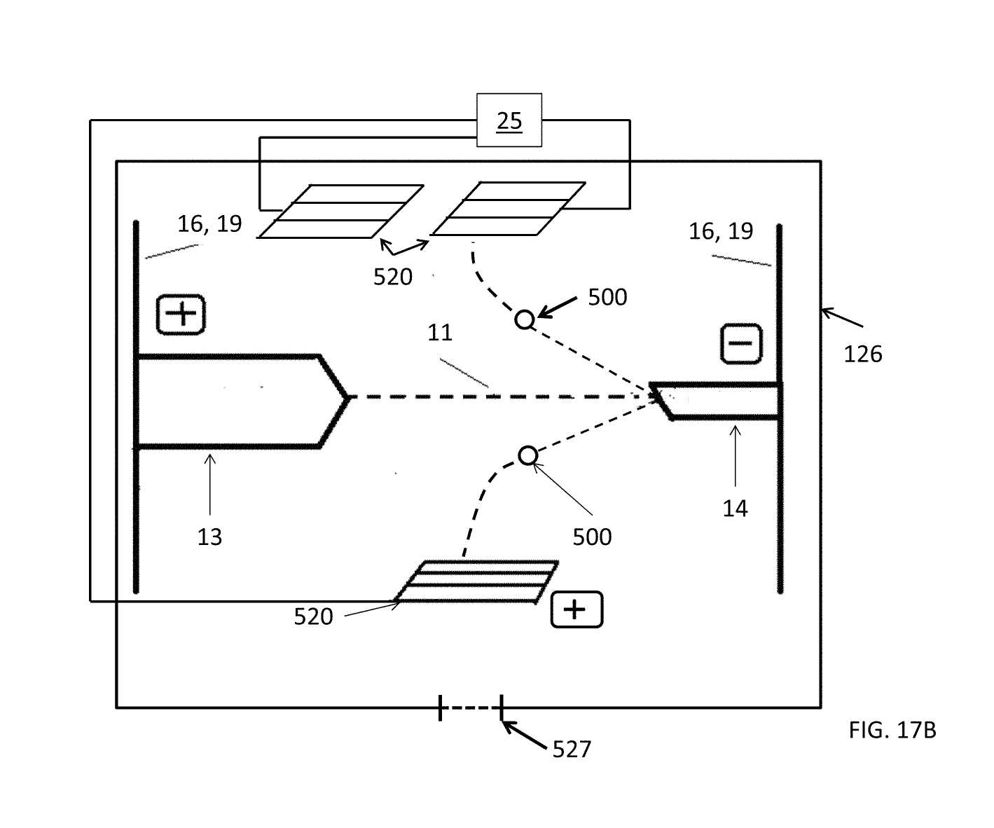

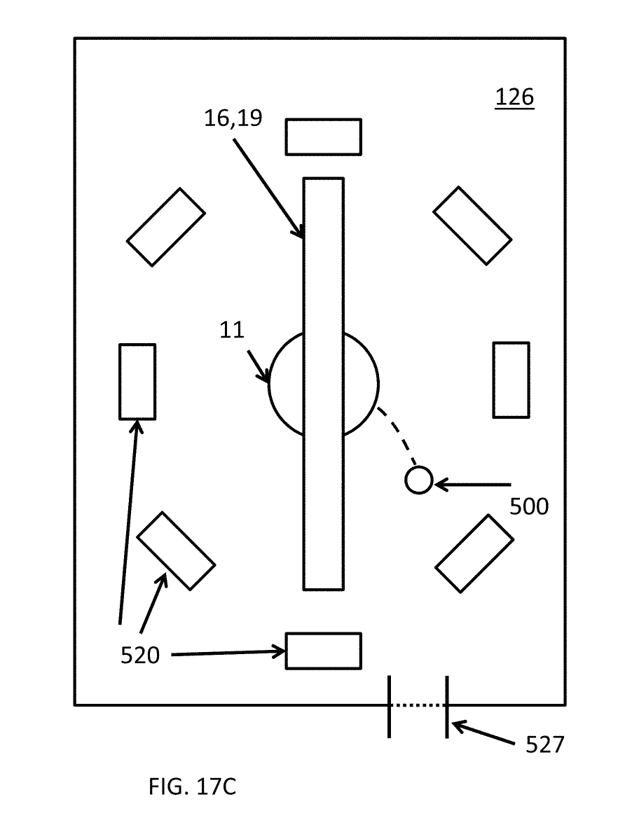

In some embodiments, this behavior of the ESTS 500 in an electric field can allow for steering and capture of the ESTS. For example, as illustrated in FIG. 17A, an electric field device 520 can be placed near the trajectory of the stand-alone ESTS 500 to change its direction of travel. In many embodiments, the electric field device can be placed at a sufficient distance from the arc 11 to avoid the arc jumping directly to the electric field device 520. The electric field device 520 can be in communication with a computing device or controller 25 in some embodiments. The computing device 25 can adjust the charge distribution on the electric field device to control the polarity, magnitude, and distribution of the electric field in the area surrounding the electric field device 520. The electric field devices as described herein can take the form of screens, plates, grids, wires, or other conductive devices in a variety of shapes and sizes to produce the desired electric field distribution in the vicinity of the arc 11.

FIGS. 17B and 17C illustrate side and end views, respectively, of an alternative embodiment of the control system described with respect to FIG. 17A. In the system shown in FIGS. 17B and 17C, multiple electric field devices 520 are employed to provide additional control of the trajectory of the stand-alone ESTS 500. In some embodiments, electric field devices 520 can be placed symmetrically across from one another with respect to an axis formed by the arc 11 to form an array. This electric field generating device can have a field distribution and magnitude control effective to capture one or more ESTS elements as they exit the arc 11. In other embodiments, different electric field devices 520 can be placed closer to or further away from the arc 11. This can be done in particular to accommodate space constraints within the vacuum chamber 126. In some embodiments, the electric field devices 520 can be placed at different axial positions along the length of the arc 11. As shown in the end view of FIG. 17C, electric field devices 520 can be positioned in an annular arrangement around the arc 11. The number of electric field devices 520 can be chosen to contour the electric field in the chamber to the degree necessary as would be understood by one of ordinary skill in the art.

The electric field devices 520 can be connected to a computing device 25 that controls the polarity and magnitude of the charge on the plate. In some embodiments, the computing device 25 can facilitate coordinated control of the multiple electric field devices 520 to evolve the electric field within the vacuum chamber 126 over time. For example, the computing device 25 can set electric field devices 520 above the arc 11 to a negative value and set the devices below the arc 11 to positive values to draw the ESTS 500 to the bottom of the chamber 126. The initial values of charge can be adjusted over time to accelerate, decelerate, or maintain the speed of the ESTS 500.

In some embodiments, the vacuum chamber 126 can include an aperture 527 through which an ESTS can pass to exit the system. In various embodiments, the aperture 527 can include a valve or gating mechanism that can be opened and closed. In some embodiments, the aperture 527 remains closed at all times when an ESTS 500 is not passing through the aperture 527. The valve can be a gate valve, isolation valve, or other fast-switching valve in some embodiments. The pressure on the external side of the aperture 527 can be different than or the same as the pressure in the vacuum chamber 126 depending upon the application.

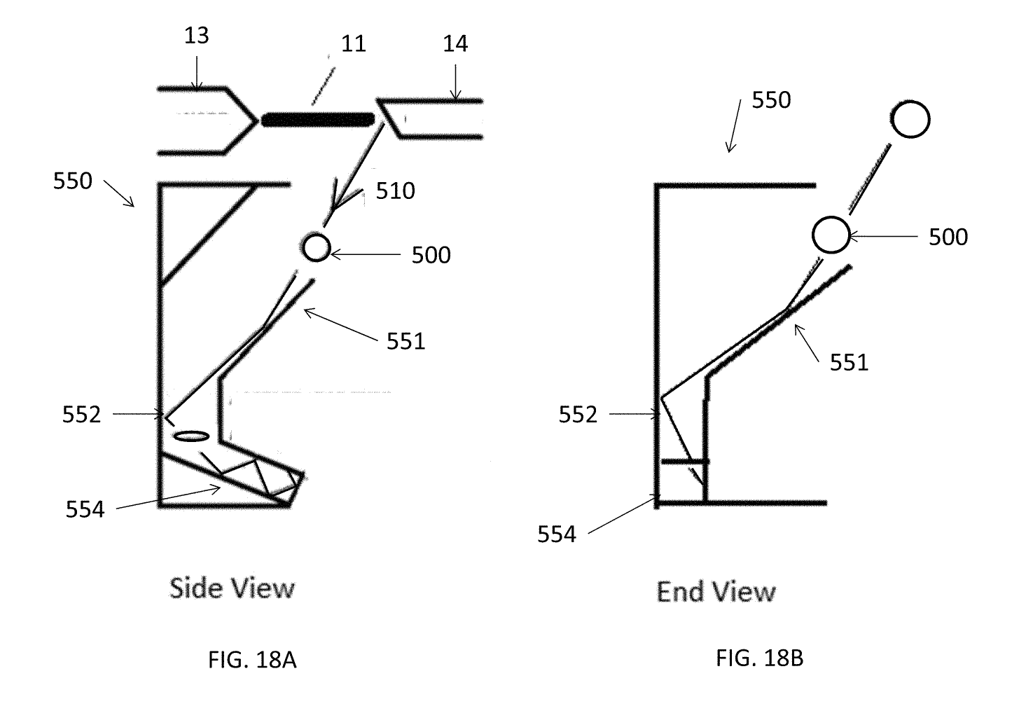

FIGS. 18A and 18B illustrate a side view and an end view of a capture system 550 for ESTS elements in accordance with various embodiments of the present invention. The capture system 500 can include a ricochet box 551 and an accelerator tube 554. The elements of the capture system 550 are designed to preferentially direct and capture electron spiral toroids 500.

As shown in FIG. 18A, ESTS elements 500 can be generated at the cathode 14 during generation of an arc 11. The ESTS 500 can be ejected from the arc 11 along a trajectory 510. The ESTS 500 can enter the ricochet box 551 and make contact with one of the walls of the ricochet box. In preferred embodiments, the walls of the ricochet box 551 can be formed substantially parallel to an expected trajectory of an ESTS to promote collisions at oblique angles. By colliding at an oblique angle, the ESTS is directed to travel deeper into the ricochet box 551. As shown, the ricochet box 551 can have a neck portion 552. In some embodiments, the ESTS 500 can be directed to travel on trajectories that are substantially parallel as they enter the neck portion 552 and can continue to travel to the accelerator tube 554. From the neck portion 552 on, the ESTS 500 can undergo an increasing number of collisions because the exit of the neck portion 552 and the entire accelerator tube 554 can have smaller cross-sections than the ricochet box 551. As the ESTS collide with the walls of the ricochet box 551, neck portion 552, or accelerator tube 554, their rotational energy and forward velocity can decrease as described above. As the energy and velocity decrease, the ESTS can become more susceptible to orientation along externally applied magnetic fields. In various embodiments, the ricochet box 551, neck portion 552, accelerator tube 554, or any combination thereof can spatially contain the electron spiral toroid. In some embodiments, the end of the accelerator tube can include an aperture 527 as described above to allow the accelerated and/or controlled ESTS 500 to exit the apparatus.

In some embodiments, the accelerator tube 554 can aim and direct the ESTS elements 500 in a specific direction or toward a specific target. Although the use of an accelerator tube 554 is shown, ESTS 500 can be accelerated in other ways without the specific use of an accelerator tube 554. However, the use of an accelerator tube 554 in certain embodiments reduces the dispersion of angle trajectories for ESTS leaving the accelerator tube over what can be achieved in free space.

In some embodiments, the structures of the capture system can be made of non-magnetic materials. Appropriate materials for elements of the capture system 550 can include, but are not limited to, glass, ceramics, and plastics. In some embodiments, clear glass and clear plastics may be preferred so that the ESTS can be observed from outside to measure properties such as direction and velocity. Metals can be inappropriate as elements of the capture system 550 as they can dissipate the charge of the ESTS and can interfere with the electric and magnetic fields used to control the ESTS. In some embodiments, the materials or elements of the capture system 550 including the ricochet box 551, the neck portion 552, or the accelerator tube 554 can be formed of a composite with one or more electrodes.

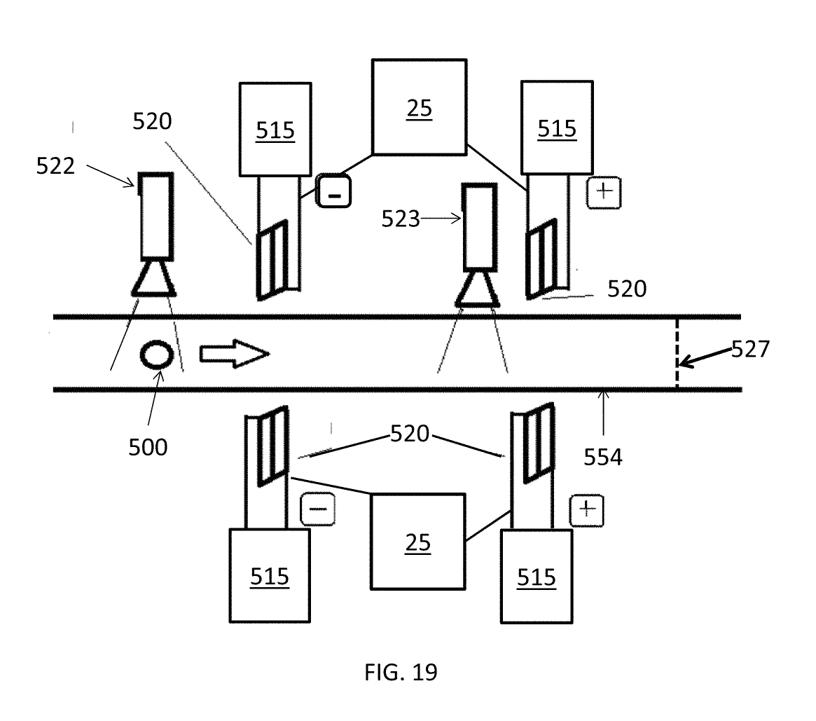

FIG. 19 illustrates the use of a series of electric field devices 520 to accelerate ESTS through an accelerator tube 554. As the ESTS enters the accelerator tube 554, the ESTS passes a first sensor 522. The first sensor 522 can sense a property of the ESTS 500, for example, a velocity. Information related to the sensed property of the ESTS can be transmitted to a computing device 25 that controls a series of electric field devices 520. The electric field devices 520 can be placed at different electric potentials using power supplies 515 to set up an electric field from negative to positive. The electric field can accelerate the ESTS as described above with relation to FIGS. 16 and 17A-C. As the ESTS 500 passes a second sensor 523, the second sensor can sense a property of the ESTS 500. For example, the second sensor 523 can sense the velocity of the ESTS 500. Information related to the sensed property of the ESTS can be transmitted to the computing device 25. In some embodiments, the computing device 25 can shut off the electric field devices 520 in response to the measured property received from the second sensor 523. In this way, the fields in the accelerator tube 554 can be reset in time to receive the next ESTS.

In some embodiments, a separate power supply 515 is provided for each magnetic field device 520. In other embodiments, at least one power supply 515 can provide power to more than one magnetic field device 520.

In some embodiments, the first sensor 522 or the second sensor 523 can be a high-speed television camera such as, for example, the FastCam SA1.1 (Photron, San Diego, Calif.). In some embodiments, the first sensor 522 or second sensor 523 can generate an external output when an ESTS is detected. In other embodiments, the first sensor 522 or second sensor 523 can include individual photodiodes or photodiode arrays. It is contemplated that one can add any number of electric field devices 520 in series in any necessary length of accelerator tube 554 to achieve a desired level of acceleration or final velocity of the ESTS.

In some embodiments, the accelerator tube 554 can include a radio frequency (RF) source and antenna to accelerate ESTS 500. In such embodiments, the first sensor 522 and second sensor 523 can detect properties of ESTS 500 such as velocity as described above. Information related to the sensed properties of the ESTS can be transmitted to the computing device 25 that controls the RF source and antenna. The computing device 25 can direct the RF source and antenna to apply successive series of RF pulses to cause acceleration of an ESTS in the accelerator tube 554. In some embodiments, nodes and antinodes of the RF pulse standing waves can be spatially and temporally adjusted to track the position of the ESTS as it travels through the tube.

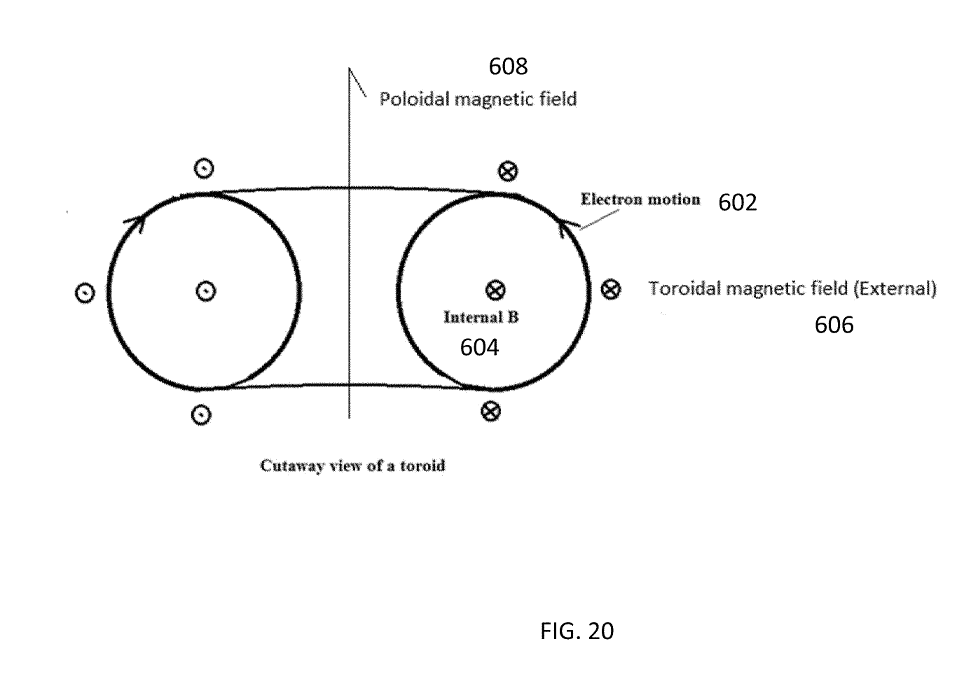

Observed ESTS can orient in some embodiments to be aligned with prevailing magnetic field lines. This property has not been observed previously in plasma toroids as previously observed toroids produced by arcs all tumble after formation except for toroids formed around the arc. FIG. 20 illustrates the magnetic fields produced by the electron spiral toroid. The electron motion 602 in the toroid creates an internal magnetic field 604. At the same time, a small amount of the internal magnetic field 604 can “leak” out a small distance and create an external toroidal magnetic field 606 that is similar to that observed for wire-wound toroids. In addition, there is a poloidal magnetic field 608 along the axis of the toroid. The poloidal magnetic field can arise from the small spiraling motion of the electrons around the entire toroid that creates a small toroidal current. In some embodiments, the poloidal magnetic field 608 can align with prevailing magnetic field lines.

In the event that a material such as steel is located near the ESTS, a magnetic field generated by the material can have an effect on the orientation of the ESTS. In some embodiments where the material includes a loop, the material can become magnetized and carry an electric current due to the magnetic fields generated by the arc during ignition. In turn, the material can generate magnetic field lines along which the ESTS will orient if the rotational energy of the ESTS has reduced to a point that the magnetic field can capture it. In particular embodiments, the rotational energy of the ESTS can be lost through collisions with portions of the capture system.

In some embodiments, the capture system 550 can include a magnetic field generator to preferentially orient stand-alone ESTS as they travel through the system. In various embodiments, the magnetic field generator can be permanent magnets, electromagnets, or a combination thereof. In some embodiments, a series of magnetic field generators can be placed through the capture system 550 to slowly evolve or rotate the orientation of the stand-alone ESTS as they pass from one point, e.g., the neck portion 552, to another point, e.g., the accelerator tube 554, in the system. The rotation of the orientation of the stand-alone ESTS can be done adiabatically in some embodiments.

In previous work, low-density, non-self-stable plasma toroids have been accelerated by magnetic fields. In addition, these plasma toroids required a containing magnetic field produced by a large, expensive apparatus in addition to that needed to produce the accelerating magnetic fields. In accordance with embodiments of the present disclosure, stand-alone ESTS 500 are self-stable and thus do not need a containing magnetic field.

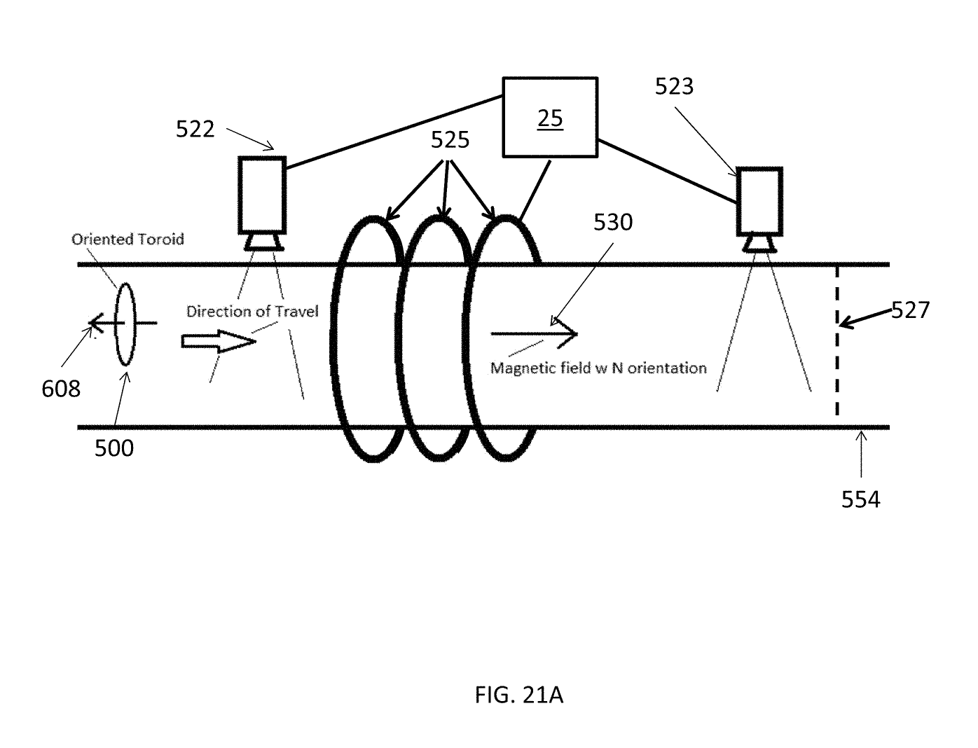

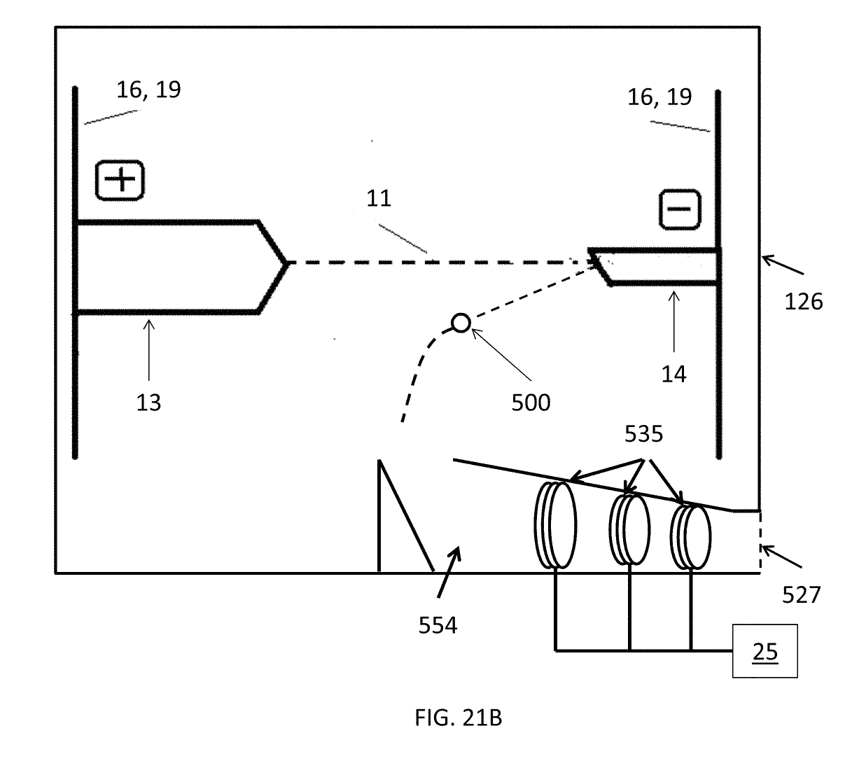

An ESTS 500 can be accelerated using magnetic fields in some embodiments. Initially, the ESTS 500 can be oriented so that it stops tumbling as described above. FIG. 21A illustrates an accelerator tube 554 including one or more magnetic accelerator coils 525 to accelerate the ESTS 500. First, an oriented ESTS enters the tube. As the ESTS enters the accelerator tube 554, the ESTS passes the first sensor 522. The first sensor 522 can sense a property of the ESTS 500, for example, a velocity. Information related to the sensed property of the ESTS can be transmitted to a computing device 25 that controls the magnetic accelerator coils 525. In some embodiments, the timing of the acceleration needed can be calculated using the sensed property from the first sensor 525 and the magnetic accelerator coils 535 can be turned on at the appropriate time.

When the magnetic accelerator coils 535 are turned on, a magnetic field 530 in a particular orientation (e.g., pointing North) is established in the accelerator tube 554. The oriented poloidal magnetic field 608 of the ESTS 500 is attracted to the magnetic field 530 and the ESTS 500 is accelerated thereby.

As the ESTS 500 passes the second sensor 523, the second sensor can sense a property of the ESTS 500. For example, the second sensor 523 can sense the velocity of the ESTS 500. Information related to the sensed property of the ESTS can be transmitted to the computing device 25. In some embodiments, the computing device 25 can stop current in the magnetic accelerator coils 525 in response to the measured property received from the second sensor 523. In this way, the magnetic accelerator coils 525 can provide a net acceleration and a net increase in velocity. The magnetic acceleration coils 535 are thus reset to prepare for entry of the next stand-alone ESTS 500 into the accelerator tube 554. By repeating this process with additional sensors and magnetic accelerator coils, any desired amount of energy can be added to the ESTS.

In some embodiments, the first or second sensors can be a high-speed television camera as described above with reference to FIG. 19. It is contemplated that one could add any number of magnetic accelerator coils 535 in series along any necessary length of accelerator tube 554 to achieve a desired level of acceleration or final velocity of the stand-alone ESTS 500.

The magnitude of the magnetic field 530 must not exceed the internal magnetic fields of the stand-alone ESTS 500. To analyze the appropriate magnetic field magnitude, note that toroids can form in arcs of between 200 A and 800 A (certain applications may require arc currents below or above this range). Because toroids form near the arc and pass near the arc (for example, to within 1 cm), the internal magnetic field of the toroid must be larger than the magnetic field produced by the arc or the toroid might be expected to come apart. The magnetic field near the arc 11 can be calculated using B=μI/2πr where μ is the permeability contest (e.g., 1.26×10⁻⁶ Henry/meter), I is the current, and r is the distance to the arc. For exemplary values of a 400 A arc at 1 cm, the magnetic field due to the arc is 80 Gauss. In some embodiments, the magnetic field 530 for acceleration of stand-alone ESTS can be greater than 80 Gauss.

As shown in FIG. 21B, multiple magnetic accelerator coils 535 can be employed to steer or accelerate an ESTS 500 in an accelerator tube 554. In some embodiments, the magnetic accelerator coils 535 can be placed inside the accelerator tube 554 and shielded from the arc 11 in the main vacuum chamber 126. By shielding the coils 535 from the arc 11, the effect of the field generated by the magnetic coils 535 on ESTS formation in the arc 11 can be reduced or eliminated. In some embodiments, the accelerator tube 554 can be maintained at a different pressure level than the main chamber. For example, a valve or aperture may be placed at the entrance to the accelerator tube 554. Although not shown in FIG. 21B, electric field devices 520 as described above can be employed in conjunction with magnetic accelerator coils 535 to achieve even greater control over motion of the ESTS 500.

In some embodiments, the magnetic accelerator coils 535 can be controlled together by the computing device 25 to produce coordinated action. For example, coils 535 closer to a detected or expected location of the ESTS 500 can be adjusted to have greater field intensity while coils 535 that are further away can have lesser field intensity. In some embodiments, the coils can be oriented within or outside the accelerator tube 554 such the magnetic field direction is perpendicular the length of the accelerator tube 554. In some embodiments, coils can be placed opposite one another with respect to the trajectory of the ESTS in a Helmholtz configuration to allow tight control of the magnitude and direction of the magnetic field in the region of the ESTS 500.

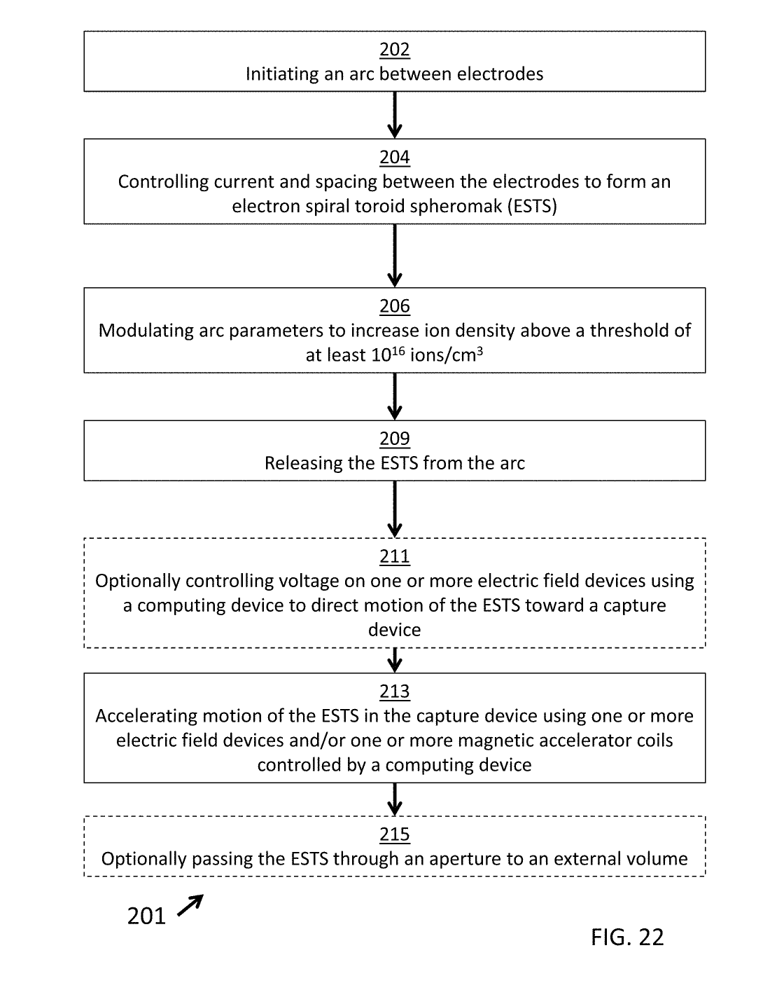

As shown in the process flow diagram 201 of FIG. 22, the ESTS can be formed, controlled, and have its motion manipulated. After initiation of an arc current 202, the current and spacing between the electrodes is controlled 204. By adjusting the arc parameters 206, a toroid having an average ion density above a threshold of at least 10¹⁶ ions/cm³ can be obtained. The ESTS can be released 209 from the arc after formation using, for example, a magnetic field. Voltage for one or more electric field devices can be controlled 211 using a computing device to steer, control, or direct the motion of the toroid towards a capture device. For example, the capture device can be the capture device 550 described above with respect to FIG. 18A-18B. Once the ESTS enters the capture device, its motion can be accelerated 213 using one or more electric field devices and/or one or more magnetic accelerator coils that are controlled by a computing device. The ESTS can remain in the capture device or optionally can be passed 215 through an aperture to an external volume.

It will be appreciated by those skilled in the art that modifications to and variations of the above-described systems and methods and equivalents thereof may be made without departing from the inventive concepts disclosed herein. Accordingly, the disclosure should not be viewed as limited except as by the scope and spirit of the appended claims.

What is claimed is:

1. A system for capturing an electron spiral toroid comprising:
a system to regulate gas pressure in a chamber;
a first electrode spaced from a second electrode by a selected separation distance within the chamber;
an actuator to provide relative movement between the first electrode and the second electrode to control the separation distance;
a power source to apply a controlled electric voltage across the separation distance to generate an electric arc;
a controller to adjust the electric voltage across the separation distance, the controller being connected to the actuator to adjust the separation distance between the first electrode and the second electrode to initiate a toroidal flow of ions around the arc; and
a capture system to capture an electron spiral toroid traveling along a trajectory, the capture system including one or more surfaces with which the electron spiral toroid can collide.

2. The system of claim 1 wherein the capture system includes an accelerator tube and a ricochet box having a neck portion that spatially contains the electron spiral toroid.

3. The system of claim 1 wherein a face of the cathode is angled at between 5 and 45 degrees with respect to the direction of the electric arc.

4. The system of claim 1, wherein the structures of the capture system are made of non-magnetic materials.

5. The system of claim 2, further comprising one or more electric field devices to accelerate the electron spiral toroid through the accelerator tube.

6. The system of claim 5, wherein at least one electric field device is a screen.

7. The system of claim 5, wherein two or more electric field devices are arranged in an array around an axis of the electric arc.

8. The system of claim 5, wherein two or more electric field devices are held at different values of electric potential.

9. The system of claim 1, further comprising a sensor to sense a property of the electron spiral toroid.

10. The system of claim 9, wherein the property is velocity.

11. The system of claim 9, further comprising a second sensor, the first and second sensors located at different positions along the trajectory.

12. The system of claim 11, wherein the first sensor and the second sensor are high-speed cameras.

13. The system of claim 9, further comprising a computing device in communication with the first sensor and in communication with an electric field device, the computer configured to change an electric potential of the electric field device in response to a measurement received from the first sensor.

14. The system of claim 2, wherein the accelerator tube further comprises a radio frequency (RF) source coupled to an antenna to apply RF pulses to the electron spiral toroid to cause acceleration of the electron spiral toroid in the accelerator tube.

15. The system of claim 1, further comprising a magnetic field generator to produce a magnetic field and wherein the capture system reduces the energy of the electron spiral toroid such that the magnetic field can preferentially orient or rotate the electron spiral toroid as it moves through the capture system.

16. The system of claim 2, wherein the accelerator tube further comprises a magnetic accelerator coil to orient or accelerate the electron spiral toroid.

17. The system of claim 1, further comprising an aperture to allow the electron spiral toroid to exit the chamber.

18. An electron spiral toroid formed using the system of claim 1.

19. A method of capturing an electric spiral toroid, comprising:
regulate a gas pressure in a chamber;
applying a controlled voltage across a separation distance between a first electrode and a second electrode in the chamber, the first and second electrodes being spaced by a selected separation distance;
controlling the electric voltage across the separation distance;
adjusting the separation distance between the first electrode and the second electrode to initiate a toroidal flow of ions around the arc; and
capturing an electron spiral toroid traveling along a trajectory by colliding the electron spiral toroid with one or more surfaces of a capture system.

20. The method of claim 19, further comprising:
controlling motion or acceleration of the electron spiral toroid using one or more electric field devices.
